(19) United States
(12) Patent Application Publication
(10) Pub. No.: US 2012/0186375 A1
(43) Pub. Date: Jul. 26, 2012

(54) Manual Height Adjustable Assembly For A Crib

(75) Inventor: James A. Sack, Elverson, PA (US)

(73) Assignee: Summer Infant (USA), Inc., Woonsocket, RI (US)

(21) Appl. No.: 13/352,780

(22) Filed: Jan. 18, 2012

Related U.S. Application Data
(60) Provisional application No. 61/434,550, filed on Jan. 20, 2011.
(60) Provisional application No. 61/567,937, filed on Dec. 7, 2011.

(51) Int. Cl. F16H 21/44

(52) U.S. Cl. 74/101

(57) ABSTRACT

A height adjustable assembly includes features that allow the height of a frame member to be manually adjusted. A locking assembly may be used to fix the position of a linkage member relative to the frame member. The locking assembly includes a locking plate that engages a protruding portion. The locking plate rotates about an axis that is parallel with a longitudinal direction of the locking plate.

### RELATED APPLICATIONS

This application claims the benefit of U.S. Provisional Patent Application No. 61/434,550, entitled “Height Adjustable Assembly for a Crib”, filed Jan. 20, 2011, which is hereby incorporated by reference in its entirety. This application also claims the benefit of U.S. Provisional Patent Application No. 61/567,937, entitled “Manual Height Adjustable Assembly for a Crib”, filed Dec. 7, 2011, which is hereby incorporated by reference in its entirety.

### BACKGROUND

The present embodiments relate generally to a height adjustable assembly and in particular to a height adjustable assembly in the form of a crib.

Cribs for young children are designed in accordance with government and industry safety standards to safely prevent a child from climbing out of the crib. Many cribs have multiple height positions for the mattress support to accommodate children of various sizes as they grow. Adjusting the mattress support typically requires all of the bedding, including the mattress, to be removed from the bed so the support can be unbolted and then reassembled at a new level. The entire process can take 30 or 40 minutes.

### SUMMARY

In one aspect, a height adjustable assembly includes a sliding member with a flange portion and a receiving member configured to receive the sliding member. The receiving member includes a slot. The receiving member also includes a distal portion and a proximal portion. The proximal portion includes a barb portion. The height adjustable assembly also includes a frame member with a recess, where the recess further includes a narrow portion and a wide portion disposed inwardly from the narrow portion. The receiving member is disposed within the recess such that the barb portion is engaged with the wide portion. The sliding member is disposed in the slot of the receiving member and wherein the flange portion is disposed inside of the wide portion of the recess.

In another aspect, a method of making a recess in a frame member for receiving a sliding assembly includes forming a first portion of the recess in the frame member, where the first portion has a substantially constant cross sectional area. The method also includes forming a second portion of the recess, where the second portion includes a cross sectional area that varies between a narrow portion and a wide portion that is disposed inwardly of the narrow portion. The narrow portion and the wide portion are formed substantially simultaneously.

In another aspect, a height adjustable assembly includes an outer support structure and a frame member that is configured to move with respect to the outer support structure. The height adjustable assembly also includes a linkage assembly used to attach the outer support structure to the mattress frame member where the linkage assembly includes a first portion and a second portion. The height adjustable assembly also includes a pedal attached to the linkage assembly and a pneumatic strut with substantial damping including a first end attached to the first portion of the linkage assembly and a second end attached to the second portion of the linkage assembly. The pedal can be depressed to operate the linkage assembly and thereby raise the mattress frame member and the pneumatic strut provides an assisting force in operating the linkage assembly. The damping is relied upon to prevent the mattress from dropping sharply when occupied.

In another aspect, a height adjustable assembly includes an outer support structure, an inner frame that is configured to move with respect to the outer support structure, where the inner frame includes an edge. The adjustable assembly also includes a linkage assembly used to attach the outer support structure to the inner frame, where the linkage assembly includes a first portion and a second portion adjacent to a side of the outer support structure. The adjustable assembly also includes a pedal attached to the linkage assembly, where the linkage assembly may be positioned between a lowered position and a raised position using the pedal. A mounting rail is mounted to the outer support structure. The first portion of the linkage assembly is attached to the edge of the inner frame and the second portion of the linkage assembly is attached to the mounting rail. An intermediate portion of the mounting rail is spaced inwardly from the edge.

In another aspect, a height adjustable assembly includes a linkage member with a first end portion and a second end portion. The assembly also includes a frame member and a sliding assembly providing a sliding connection between the first end portion of the linkage member and the frame member. The assembly also includes a protruding portion extending from the first end portion of the linkage member and a locking plate comprising a plurality of openings for engaging the protruding portion. The locking plate includes a longitudinal direction associated with a length of the locking plate and a lateral direction associated with a width of the locking plate. The locking plate can be rotated about a first axis extending in the longitudinal direction of the locking plate.

In another aspect, a height adjustable assembly includes a frame member and a linkage member that is configured to move with respect to the frame member. The assembly also includes a locking plate comprising a plurality of openings. The assembly also includes a protruding portion that engages one or more of the plurality of openings. The protruding portion extends outwardly from the linkage member. The locking plate includes a longitudinal direction associated with a length of the locking plate and the locking plate includes a lateral direction associated with a width of the locking plate. The locking plate includes an upper edge of the locking plate, where the upper edge extends in the longitudinal direction. The locking plate may move between an engaged position where the protruding portion is inserted through one of the plurality of openings and a disengaged position where the protruding portion is removed from the plurality of openings. The position of the upper edge remains fixed as the locking plate moves between the engaged and disengaged positions.

Other systems, methods, features and advantages will be, or will become, apparent to one of ordinary skill in the art upon examination of the following figures, and detailed description. It is intended that all such additional systems, methods, features and advantages be included within this description and this summary, and be protected by the following claims.

### BRIEF DESCRIPTION OF THE DRAWINGS

The embodiments can be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIG. 1 is an isometric view of an embodiment of a height adjustable assembly in the form of a crib;

FIG. 2 is an exploded isometric view of an embodiment of a height adjustable assembly;

FIG. 3 is an isometric view of an embodiment of a height adjustable assembly in which a mattress is raised;

FIG. 4 is an isometric view of an embodiment of a height adjustable assembly in which a mattress is lowered;

FIG. 5 is an isometric view of an embodiment of components of a sliding assembly including a receiving member and a sliding member;

FIG. 6 is an enlarged cross-sectional view of a sliding assembly associated with an outer frame member;

FIG. 7 is an exploded isometric view of an embodiment of a sliding assembly associated with a frame member;

FIG. 8 is an isometric view of an embodiment of a process for forming a recess in a frame member;

FIG. 9 is an isometric view of an embodiment of a process for forming a recess in a frame member;

FIG. 10 is an isometric view of an embodiment of a process for inserting a receiving member into a recess;

FIG. 11 is an isometric view of an embodiment of a frame member with a receiving member inserted into a recess;

FIG. 12 is an isometric view of an embodiment of a sliding member inserting into a frame member;

FIG. 13 is an isometric view of another embodiment of a height adjustable assembly in a raised position;

FIG. 14 is an isometric view of the height adjustable assembly of FIG. 13 in a lowered position;

FIG. 15 is an isometric view of another embodiment of a height adjustable assembly in a raised position;

FIG. 16 is an isometric view of an embodiment of a bracket of the height adjustable assembly of FIG. 15;

FIG. 17 is an isometric view of an embodiment of a bracket of the height adjustable assembly of FIG. 15 with a sliding assembly;

FIG. 18 is an isometric view of an embodiment of a pedal assembly with a locking system;

FIG. 19 is an isometric isolated view of a pedal of the pedal assembly of FIG. 18;

FIG. 20 is an isometric view of the pedal assembly of FIG. 18 in a locked position;

FIG. 21 is an isometric view of the pedal assembly of FIG. 18 in an unlocked position;

FIG. 22 is an isometric view of an embodiment of a pedal assembly with a latch;

FIG. 23 is a side view of the pedal assembly of FIG. 22 in a locked position;

FIG. 24 is a side view of the pedal assembly of FIG. 22 in an unlocked position;

FIG. 25 is an isometric view of another embodiment of an adjustable assembly that includes mounting rails for securing part of a linkage assembly to an outer support structure, in which the adjustable assembly is in a raised position;

FIG. 26 is an isometric view of the adjustable assembly of FIG. 25, in which the adjustable assembly is in a lowered position;

FIG. 27 is an isometric view of an embodiment of a mounting rail for an adjustable assembly;

FIG. 28 is a top down view of the adjustable assembly of FIG. 25;

FIG. 29 is an enlarged view of a portion of the adjustable assembly of FIG. 28;

FIG. 30 is an isometric view of one portion of an embodiment of a linkage assembly, in which a pedal is in a locked position;

FIG. 31 is an isometric view of one portion of the linkage assembly of FIG. 30, in which the pedal is in an unlocked position;

FIG. 32 is an isometric view of one portion of the linkage assembly of FIG. 30, in which the linkage assembly is in a partially raised position;

FIG. 33 is an isometric view of one portion of the linkage assembly of FIG. 30, in which the linkage assembly is in a fully raised position;

FIG. 34 is an isometric view of an embodiment of a height adjustable assembly in a fully lowered position including an enlarged view of a sliding assembly;

FIG. 35 is an isometric view of an embodiment of a height adjustable assembly in a fully raised position including an enlarged view of a sliding assembly;

FIG. 36 is a schematic view of another embodiment of a height adjustable assembly;

FIG. 37 is an enlarged isometric view of a portion of the height adjustable assembly of FIG. 36;

FIG. 38 is an isometric view of an embodiment of a locking assembly with a portion of a height adjustable assembly;

FIG. 39 is an isometric exploded view of the locking assembly of FIG. 38;

FIG. 40 is a schematic view of an embodiment of a height adjustable assembly adjusted to a maximum height with a locking plate in an engaged position;

FIG. 41 is a schematic enlarged view of a locking assembly in an engaged position while the height adjustable assembly is in the position of FIG. 40;

FIG. 42 is a schematic enlarged view of a locking assembly in a disengaged position while the height adjustable assembly is in the position of FIG. 40;

FIG. 43 is a schematic enlarged view of an embodiment of a locking assembly in a disengaged position while the position of a linkage assembly is changed;

FIG. 44 is a schematic enlarged view of an embodiment of a locking assembly in an engaged position;

FIG. 45 is a schematic view of an embodiment of a height adjustable assembly adjusted to an intermediate height;

FIG. 46 is a schematic isometric view of an embodiment of a sliding assembly guard for a height adjustable assembly where the height adjustable assembly is in a raised position; and

FIG. 47 is a schematic isometric view of an embodiment of a sliding assembly guard for a height adjustable assembly where the height adjustable assembly is in a lowered position.

### DETAILED DESCRIPTION

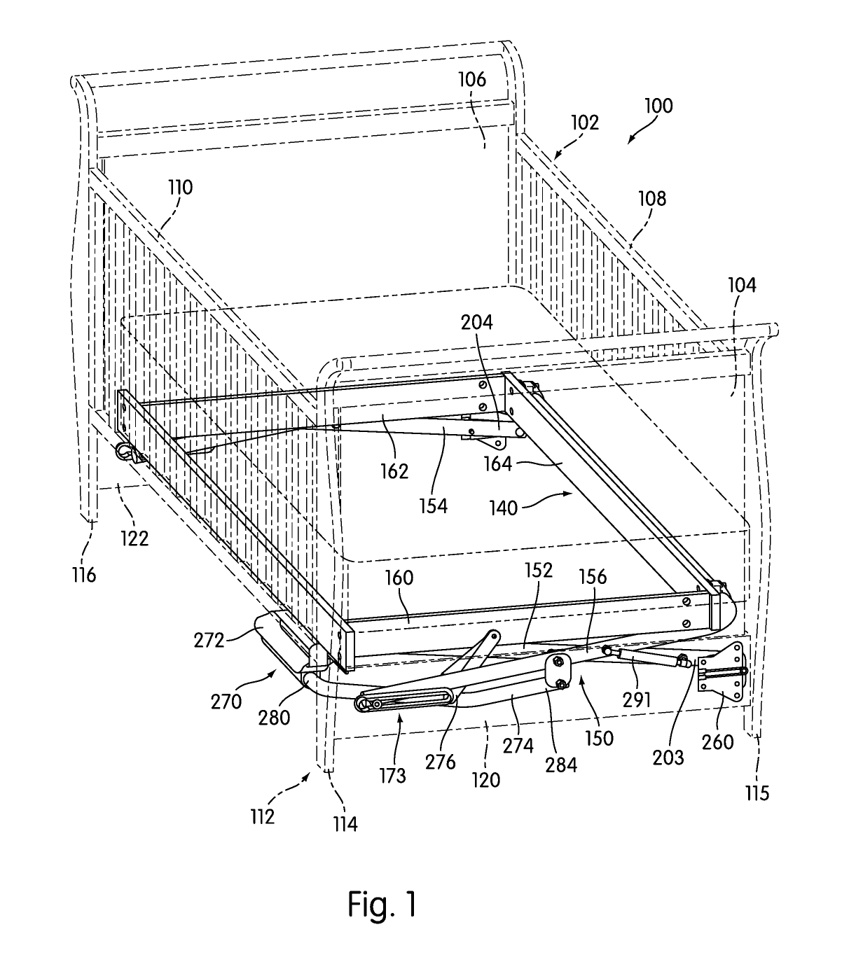

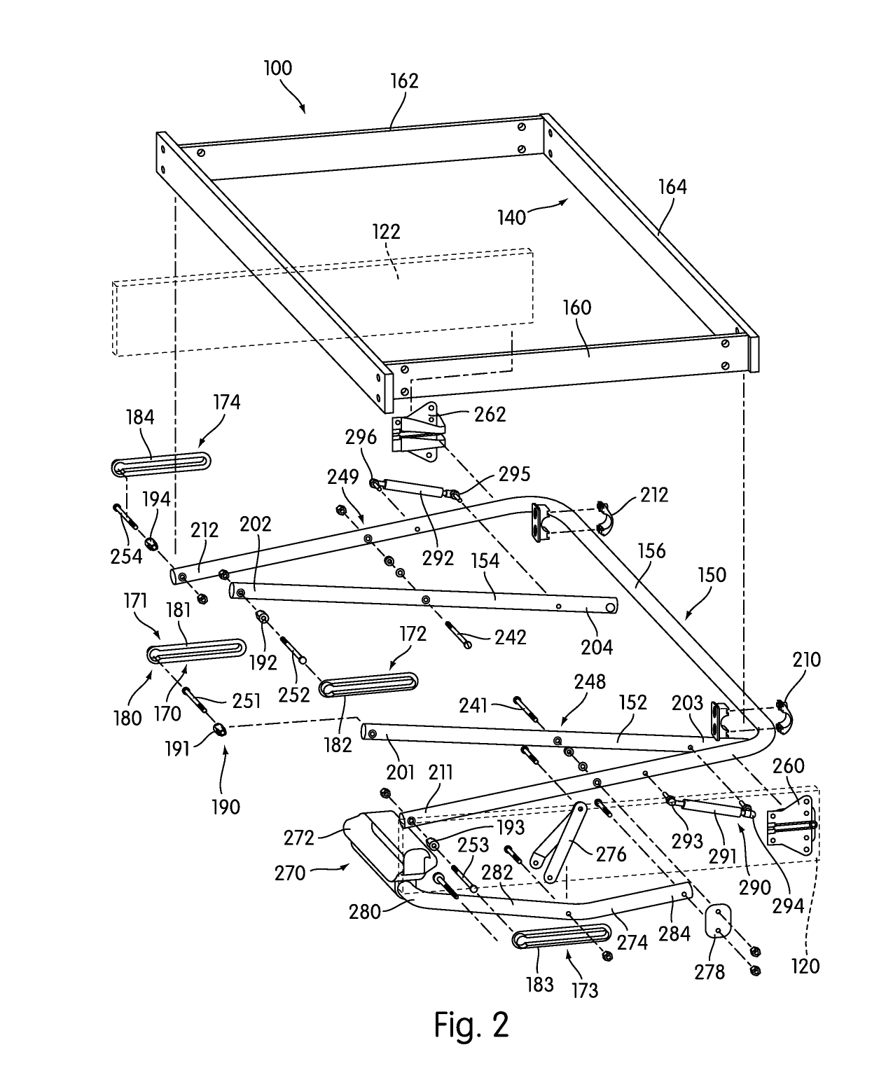

FIGS. 1 and 2 illustrate an embodiment of a height adjustable assembly 100. In particular, FIG. 1 illustrates an isometric view of height adjustable assembly 100 with some components shown in phantom, while FIG. 2 illustrates an exploded isometric view of various components of height adjustable assembly 100. In the current embodiment, height adjustable assembly 100, also referred to hereafter as simply assembly 100 has the form of a crib. However, in other embodiments, assembly 100 may be associated with various other structures where it is required to adjust the height of one or more components. Moreover, the specific configuration for the crib shown in FIGS. 1 and 2 is only intended to be exemplary and in other embodiments the crib could have any other shape, size and design.

For consistency and convenience, directional adjectives are employed throughout this detailed description corresponding to the illustrated embodiments. The term “longitudinal” as used throughout this detailed description and in the claims refers to a direction extending a length or major axis of a member. Also, the term “lateral” as used throughout this detailed description and in the claims refers to a direction extending a width or minor axis of a member. Furthermore, the term “vertical” as used throughout this detailed description and in the claims refers to a direction generally perpendicular to a lateral and longitudinal direction. Additionally, proximal refers to a direction that is closer to the center or of a component while distal refers to a direction that is further from the center of a component.

Assembly 100 may include outer support structure 102 (shown in FIG. 1 only). In some cases, outer support structure 102 can include various components associated with a crib. For example, in some cases outer support structure 102 can include first side panel 104 and second side panel 106 as well as first rail 108 and second rail 110. In addition, outer support structure 102 can include legs 112 that comprise first leg 114, second leg 115, third leg 116 and a fourth leg (not shown).

Assembly 100 can also be associated with one or more frame members. The term “frame member” as used throughout this detailed description and in the claims refers to any component of an assembly that provides support for one or more components. In some embodiments, assembly 100 can include first outer frame member 120 and second outer frame member 122. First outer frame member 120 and second outer frame member 122 may be a portion of outer support structure 102. In addition, in some cases, first outer frame member 120 may be disposed below first side panel 104 and second outer frame member 122 may be disposed below second side panel 106. Furthermore, first outer frame member 120 may be disposed between first leg 114 and second leg 115, while second outer frame member 122 may be disposed between third leg 116 and a fourth leg disposed opposite of third leg 116. Using this arrangement, first outer frame member 120 and second outer frame member 122 may provide increased structural support for outer support structure 102.

In some embodiments, first outer frame member 120 and second outer frame member 122 may be integrated with other portions of outer support structure 102. For example, in some cases, first outer frame member 120 and second outer frame member 122 may be portions of first side panel 104 and second side panel 106, respectively. However, in other embodiments, first outer frame member 120 and second outer frame member 122 could be distinct members of outer support structure 102. Furthermore, in still other embodiments an outer frame member could be associated with any other portion of outer support structure 102.

In some embodiments, assembly 100 may be associated with inner frame member 140. Inner frame member 140 may be a separate component from outer support structure 102. In embodiments where assembly 100 is associated with a crib, inner frame member 140 may comprise a frame for supporting a mattress or any other kind of bedding surface. Moreover, inner frame member 140 may be disposed within outer support structure 102 and supported by outer support structure 102.

In the current embodiment, inner frame member 140 is shown as a simple rectangular frame comprising four distinct pieces. In other embodiments, inner frame member 140 could have any geometry and could comprise a single monolithic piece or multiple pieces. For purposes of illustration, inner frame member 140 is shown in the current embodiment without an upper surface. However, in some embodiments inner frame member 140 could include an upper surface that helps to support the center of a mattress or other bedding component.

Assembly 100 can include provisions that allow inner frame member 140 to move with respect to outer support structure 102. For example, in some cases, outer support structure 102 is configured to remain stationary while inner frame member 140 moves in a vertical direction within outer support structure 102.

In some embodiments, inner frame member 140 may be attached to outer support structure 102 using linkage assembly 150. Linkage assembly 150 may include first linkage member 152, second linkage member 154 and third linkage member 156. First linkage member 152 is associated with first side 160 of inner frame member 140 and second linkage member 154 may be associated with second side 162 of inner frame member 140. In addition, third linkage member 156 may be associated with rear side 164 of inner frame member 140.

In different embodiments, the geometries of one or more linkage members could vary. In some cases, a linkage member could have a tube-like geometry. In other cases, a linkage member could have a flattened geometry. Moreover, in some cases one or more linkage members could be substantially straight. In other cases, one or more linkage members could be curved. In one embodiment, first linkage member 152 and second linkage member 154 comprise substantially straight tube-like members. Also, in one embodiment, third linkage member 156 may comprise a U-shaped tube-like member. It will be understood that other embodiments are not restricted to linkage members with a particular kind of geometry.

Assembly 100 can include sliding assemblies 170 that allow the ends of linkage members to slide with respect to outer frame members and inner frame members. Sliding assemblies 170 include first sliding assembly 171, second sliding assembly 172, third sliding assembly 173 and fourth sliding assembly 174. In some cases, each sliding assembly connects an end portion of a linkage member to a frame member. For example, first sliding assembly 171 may be configured to attach end portion 201 of first linkage member 152 and first side 160 of inner frame member 140. Also, second sliding assembly 172 may be configured to attach end portion 202 of second linkage member 154 and second side 162 of inner frame member 140. Furthermore, third sliding assembly 173 may be configured to attach end portion 211 of third linkage member 156 to first outer frame member 120, while fourth sliding assembly 174 may be configured to attach end portion 212 of third linkage member 156 to second outer frame member 122. Using this arrangement, each sliding assembly provides for a sliding arrangement between the end portions of each linkage member and the associated frame members. For example, first sliding assembly 171 allows a sliding connection between end portion 201 of first linkage member 152 and inner frame member 140.

Each sliding assembly further includes receiving members 180 and sliding members 190. For example, first sliding assembly 171 includes first receiving member 181 and first sliding member 191. Likewise, second sliding assembly 172 includes second receiving member 182 and second sliding member 192, third sliding assembly 173 includes third receiving member 183 and third sliding member 193 and fourth sliding assembly 174 includes fourth receiving member 184 and fourth sliding member 194. Details of the sliding members and the receiving members are discussed in detail below.

Assembly 100 can include one or more pivot assemblies that provide a pivoting connection between various components. In some cases, assembly 100 includes first pivot assembly 210 and second pivot assembly 212. First pivot assembly 210 and second pivot assembly 212 provide a pivoting connection between third linkage member 156 and rear side 164 of inner frame member 140. In particular, first pivot assembly 210 and second pivot assembly 212 allow third linkage member 156 to rotate with respect to inner frame member 140. This allows the orientation of third linkage member 156 and inner frame member 140 to be changed as inner frame member 140 is raised and lowered.

In some embodiments, first pivot assembly 210 and second pivot assembly 212 can each comprise two interlocking components that wrap around third linkage member 156. In some cases, these interlocking components can snap together when they are engaged in order to provide for ease of assembly by a user. Moreover, first pivot assembly 210 and second pivot assembly 212 can be attached directly to inner frame member 140 using any kind of fasteners.

The components of linkage assembly 150 and sliding assemblies 170 can be attached in a variety of different ways. FIG. 2 illustrates one possible arrangement for securing these components together. For example, first fastener 241 and second fastener 242 may be used to connect first linkage member 152 and second linkage member 154, respectively, to third linkage member 156. Furthermore, first sliding fastener 251, second sliding fastener 252, third sliding fastener 253 and fourth sliding fastener 254 may be used to attach sliding assemblies 170 to linkage assembly 150 and corresponding frame members. For example, first sliding fastener 251 is used to fasten first sliding member 191 with first linkage member 152 and inner frame member 140. In particular, first sliding member 191 is secured to end portion 201 of first linkage member 152 using first sliding fastener 251. Further details of the attachment of sliding assemblies to linkage members and frame members are discussed in detail below.

In some embodiments, end 203 of first linkage member 152 and end 204 of second linkage member 154 can be secured directly to first outer frame member 120 and second outer frame member 122 (see FIG. 1), respectively. In some cases, end 203 may be secured using first bracket 260. Also, in some cases, end 204 may be secured using second bracket 262.

It will be understood that any types of fasteners may be used for securing various different components together. In some cases, a fastener could comprise a bolt with a nut. In other cases, a fastener could include screws, nails, pins, rivets or any other kinds of fasteners known in the art. In particular, each fastener may be selected according to the specific features of the components being connected. In embodiments where assembly 100 is configured to be assembled by a customer or user, the fasteners could be selected to provide increased ease of assembly. For example, in some embodiments, most or all connections could be factory riveted in order to facilitate ease of assembly by the user. In some embodiments, each fastener described above could be a rivet except for the fasteners used to connect a linkage member directly to an outer support structure. This would minimize the amount of assembly required by a user, since most connections are made at the factory. Examples of such a design are described in detail below.

In some cases, some fasteners may provide a pivoting connection between two or more components. For example, first fastener 241 may facilitate a first pivoting connection 248 between first linkage member 152 and third linkage member 156. Likewise, second fastener 242 may facilitate a second pivoting connection 249 between second linkage member 154 and third linkage member 156. In other cases, some fasteners may fasten two components in a manner that restricts or prevents any relative rotation or movement.

A height adjustable assembly can include provisions for operating a linkage assembly in order to raise and lower an inner frame member. In some embodiments, an actuating device can be used to operate the linkage assembly.

In one embodiment, a pedal assembly may be used in combination with a strut system to operate the linkage assembly.

Assembly 100 may include pedal assembly 270 for operating linkage assembly 150. In some cases, pedal assembly 270 includes pedal 272, pedal linkage member 274 and harness 276. Pedal linkage member 274 may connect pedal 272 with linkage assembly 150. In some cases, end 280 of pedal linkage member 274 may be attached to pedal 272.

In some cases, harness 276 is fastened directly to a portion of outer support structure 102. For example, in some cases, harness 276 attaches to first side panel 104. In other embodiments, harness 276 could be attached to any other portion of assembly 100. It may be desirable to attach harness 276 to a portion of assembly 100 that is fixed in place and does not move as pedal 272 is depressed. Harness 276 is further connected to intermediate portion 282 of pedal linkage member 274.

In some cases, end 284 of pedal linkage member 274 is connected to plate 278. Plate 278 may also be coupled with first linkage member 152 and third linkage member 156 at the location of first fastener 241. With this arrangement, as pedal linkage member 274 pivots, end 284 applies an upward force to linkage assembly 150. This results in an upward extension of linkage assembly 150, which facilitates the raising of inner frame member 140.

Assembly 100 can include strut system 290. Strut system 290 includes first strut 291 and second strut 292. First strut 291 may be associated with first linkage member 152 and third linkage member 156. In particular, first end portion 293 may be attached to end 203 of first linkage member 152 and second end portion 294 may be attached to third linkage member 156. In some cases, second end portion 294 may be attached at a portion of third linkage member 156 that is adjacent to first pivoting connection 248. Second strut 292 may be associated with second linkage member 154 and third linkage member 156. In particular, first end portion 295 may be attached to end 204 of second linkage member 154 and second end portion 296 may be attached to a portion of third linkage member 156 that is adjacent to second pivoting connection 249.

The particular locations of first strut 291 and second strut 292 shown in the Figures are only intended to be exemplary. In other embodiments, the locations of each strut could vary in order to modify the mechanical advantage provided by strut system 290 in operating linkage assembly 150. Furthermore, while the current embodiment includes two distinct struts, in other embodiments a single strut could be used in combination with a pedal assembly.

In different embodiments, various different kinds of struts could be used. In some cases, pneumatic struts could be used. For example, in one embodiment gas struts could be used. In other cases, any other kinds of struts known in the art may be used. In some embodiments the type of strut may be selected according to the amount of force required to facilitate the operation of a height adjustable assembly.

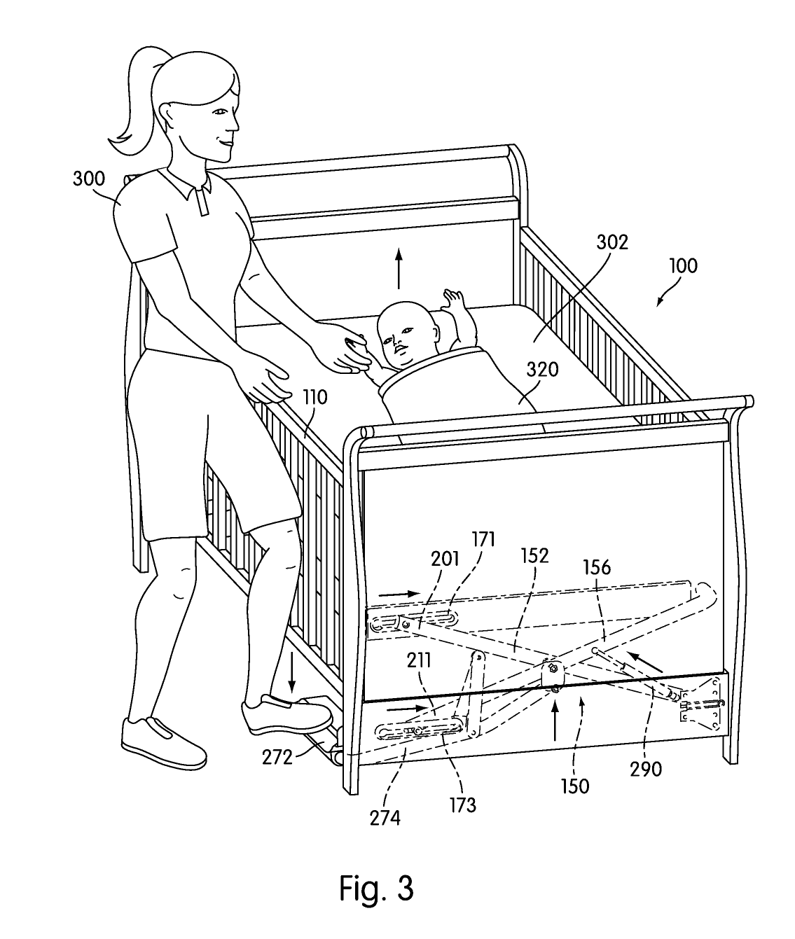

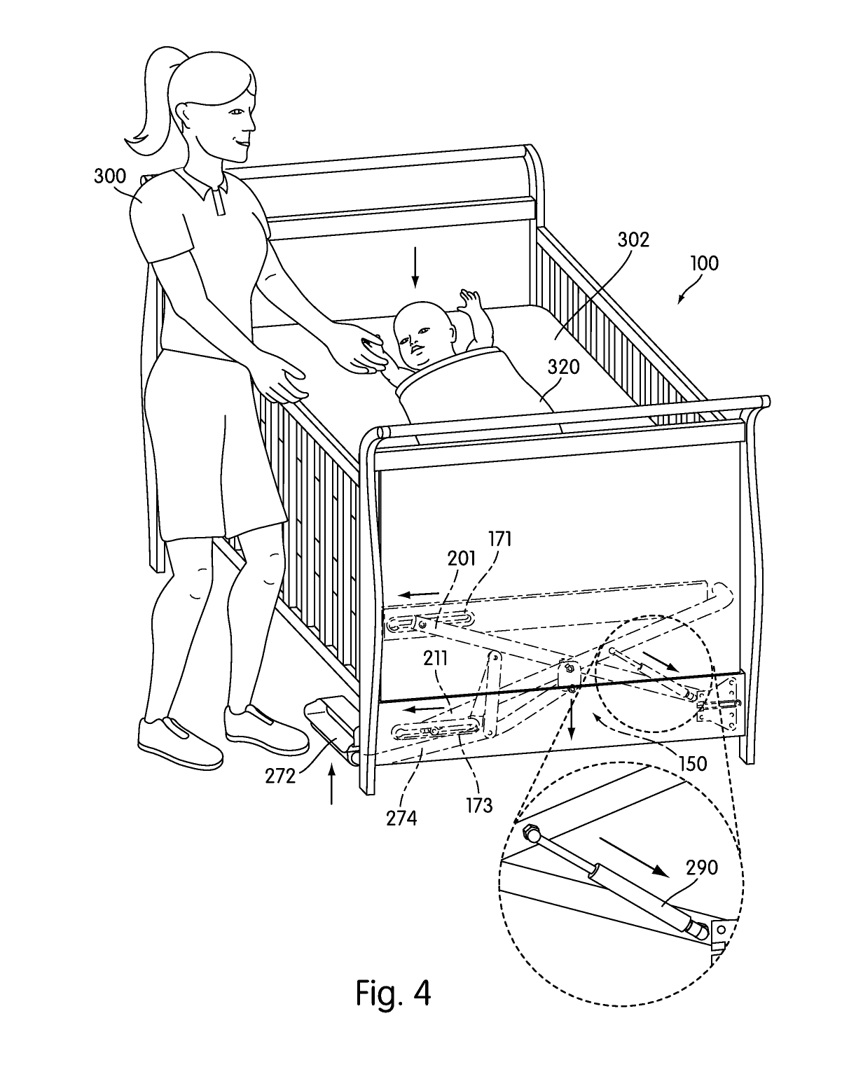

FIGS. 3 and 4 illustrate an embodiment of the operation of assembly 100. Referring to FIGS. 3 and 4, to raise the height of mattress 302, user 300 may depress pedal 272. As pedal 272 is depressed, pedal linkage member 274 applies an upward force to linkage assembly 150. In order to reduce the force that user 300 must apply to pedal 272 to extend linkage assembly 150, strut system 290 may supply an assisting force. As seen in FIG. 3, as linkage assembly 150 is extended, end 201 and end 211 of first linkage member 152 and third linkage member 156, respectively, are translated in a rearward direction due to their connections with first sliding assembly 171 and third sliding assembly 173.

As mattress 302 is raised, user 300 may more easily reach child 320 over second rail 110. This arrangement may reduce back strain by reducing the degree to which user 300 must bend over in picking up child 320.

Referring now to FIG. 4, as user 300 removes her foot from pedal 272, linkage assembly 150 may contract under the weight of child 320. However, strut system 290 provides an upward force against gravity that helps to reduce the net downward force. As a result, linkage assembly 150 contracts at a very slow rate. This ensures that mattress 302 is lowered at a similarly slow rate.

In different embodiments the effective spring force provided by strut system 290 could be varied. In some cases, the effective spring force can be selected so that linkage assembly 150 is fully extended when no child is placed in the crib. In some cases, the effective spring force can be tuned so that linkage assembly 150 contracts under a predetermined amount of weight. In some embodiments, the predetermined weight may be associated with a minimum expected weight for a child using the crib. In some cases, the effective spring force may be set at the time of manufacturing. In other cases, the effective spring force could be varied by a user to accommodate a range of different weights for children. In some embodiments, a strut can incorporate a gas spring piston such as a check valve acting in a restricted orifice to prevent accidental rapid descent of the mattress.

It should be understood that FIGS. 3 and 4 are intended to illustrate the general principles of the embodiments whereby a linkage assembly with a strut assisted pedal assembly is used to raise, and provide dampened descent of, a mattress frame. In other embodiments, specific features of a linkage assembly could be varied, including the connection of the pedal assembly with the linkage assembly as well as the placement of one or more struts. However, the same operating principles may generally apply in these other embodiments so that as a user depresses a pedal, a strut system helps provide an assisting force for raising a mattress frame with a linkage assembly. Likewise, in these other embodiments, the strut system helps to facilitate dampened descent so that the mattress frame does not drop sharply when occupied.

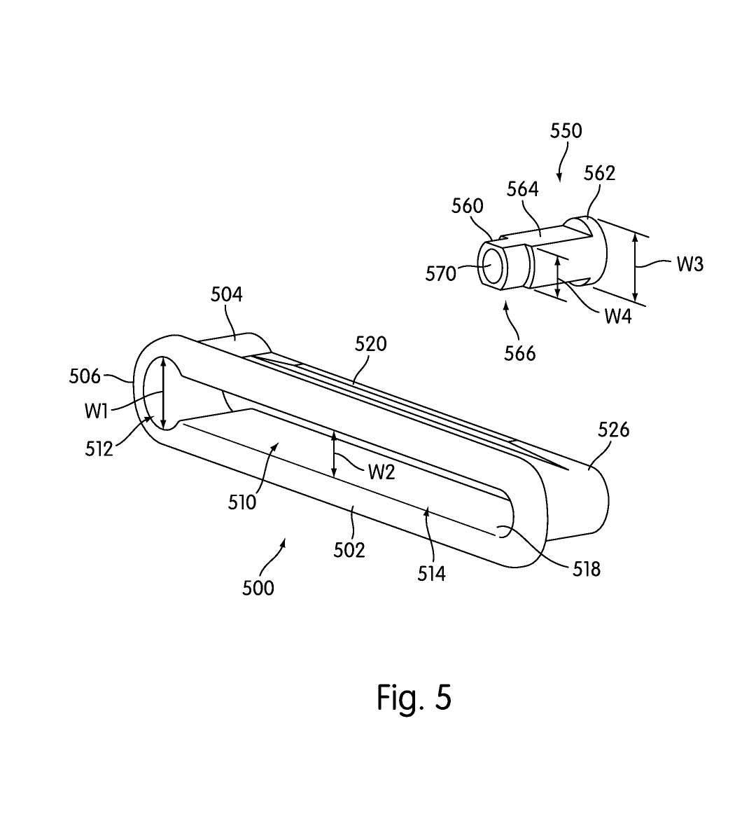

FIG. 5 illustrates isolated isometric views of receiving member 500 and sliding member 550. Although a single receiving member 500 and a single sliding member 550 are discussed in detail below, it will be understood that the descriptions of receiving member 500 and sliding member 550 may apply to any of receiving members 180 and sliding members 190.

In some embodiments, receiving member 500 includes distal portion 502 and proximal portion 504. Here, the terms proximal and distal refer to positions relative to a central axis of an associated frame member (not shown). Distal portion 502 may be configured to face outwardly from a frame member, while proximal portion 504 may insert into a recess of a frame member, as discussed in further detail below. In some cases, distal portion 502 includes flange portion 506 that may rest against an outer surface of a frame member.

In different embodiments, the geometry of receiving member 500 could vary. In some embodiments, receiving member 500 may generally have an elongated shape. Furthermore, receiving member 500 can include slot 510. Slot 510 may include first portion 512 and second portion 514. First portion 512 may be generally rounded. In some cases, first portion 512 may be approximately circular. Second portion 514 may be generally elongated. In some cases, second portion 514 may extend along a longitudinal direction of receiving member 500.

In some cases, the cross-sectional widths of first portion 512 and second portion 514 may vary. In one embodiment, first portion 512 may be associated with cross-sectional width W1 that extends in a generally lateral direction of receiving member 500. In embodiments where first portion 512 is approximately circular in cross-sectional shape, width W1 may approximately correspond to the diameter of first portion 512. In one embodiment, second portion 514 may be associated with cross-sectional width W2 that also extends in a generally lateral direction. In some cases, width W1 may be substantially larger than width W2. In other cases, width W1 may be substantially smaller than width W2. In still other cases, width W1 may be approximately equal to width W2. In one embodiment, width W1 may be larger than width W2 to provide a larger opening for receiving sliding member 550.

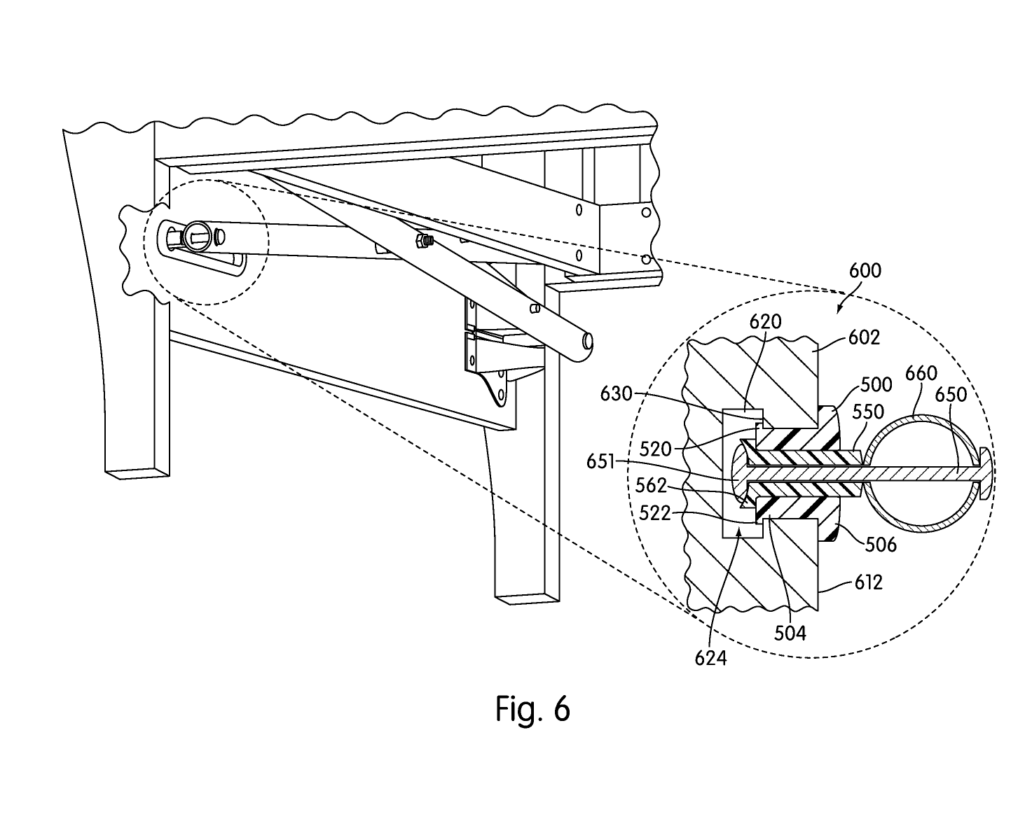

In some embodiments, receiving member 500 includes provisions for engaging with a recess in a frame member. In some cases, receiving member 500 may include a barb portion. The term “barb portion” as used throughout this detailed description and in the claims refers to a raised or projecting portion that is configured to engage or catch on the edge of another component. In this embodiment, receiving member 500 may include first barb portion 520 and second barb portion 522 (see FIG. 6). First barb portion 520 and second barb portion 522 project outwardly from edge 526 of portion 504. In particular, both first barb portion 520 and second barb portion 522 may extend in the lateral and longitudinal directions of receiving member 500. With this arrangement, first barb portion 520 and second barb portion 522 may be configured to confront an inner surface of a recess in a frame member in order to lock sliding member 550 into place. This arrangement is discussed in detail below.

Sliding member 550 may include base portion 560 and flange portion 562. Base portion 560 may be configured to engage with slot 510 of receiving member 500. Flange portion 562 may extend outwardly from base portion 560.

In different embodiments, the geometry of base portion 560 and flange portion 562 may vary. In some cases, base portion 560 comprises a generally flat upper surface 564 and lower surface 566 that may confront inner surface 518 of slot 510. In some cases, flange portion 562 has a generally rounded shape. In one embodiment, flange portion 562 is approximately circular. In addition, flange portion 562 may be associated with width W3, while base portion 560 may be associated with width W4. In some cases, width W3 may be configured so that sliding member 550 can fit through first portion 512 of slot 510 but not second portion 514. In other words, width W3 may be less than width W1, but greater than width W2. In addition, width W4 may be approximately similar to width W2, which allows base portion 560 to move within second portion 514 of slot 510.

In some embodiments, base portion 560 can include provisions for connecting with other components of a height adjustable assembly. For example, in some cases, base portion 560 includes fastening hole 570. Fastening hole 570 may be configured to engage any type of fastener. In some cases, sliding member 550 may be attached to a linkage member using a fastener that is inserted through fastening hole 570.

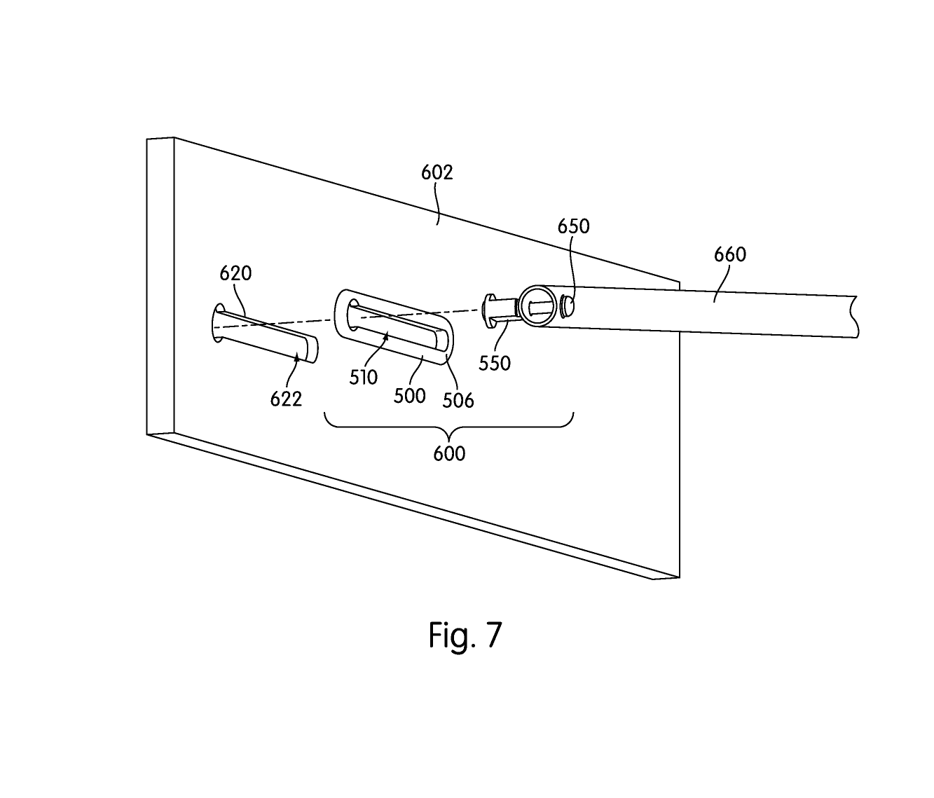

FIGS. 6 and 7 illustrate views of an embodiment of sliding assembly 600, including receiving member 500 and sliding member 550. In particular, FIG. 6 illustrates an enlarged cross-sectional view of sliding assembly 600 inserted within frame member 602 while FIG. 7 illustrates an exploded isometric view of sliding assembly 600.

As seen in FIGS. 6 and 7, frame member 602 includes recess 620. Recess 620 includes narrow portion 622 and wide portion 624. Narrow portion 622 is open on outer surface 612 of frame member 602. Wide portion 624 is disposed inwardly of narrow portion 622.

In some embodiments, receiving member 500 may be disposed within recess 620 so that proximal portion 504 fits within narrow portion 622 of recess 620. However, first barb portion 520 and second barb portion 522 may be configured to extend into wide portion 624. In particular, first bar portion 520 and second barb portion 522 may confront interior wall 630 of recess 620. In addition, flange portion 506 of receiving member 500 is configured to confront outer surface 612 of frame member 602. This arrangement allows flange portion 506, first barb portion 520 and second barb portion 522 to lock receiving member 500 in place by restricting the motion of receiving member 500 into and out of recess 620.

Sliding member 550 may be inserted through slot 510 of receiving member 500. In addition, flange portion 562 may confront rear portion 504 of receiving member 500 so that sliding member 550 cannot pass through slot 510 in an outward direction. Moreover, fastening member 650 may attach sliding member 550 to linkage member 660. This attachment to linkage member 660 helps maintain the alignment of sliding member 550 within slot 510 and may generally prevent sliding member 550 from moving further into recess 620. With this arrangement, sliding member 550 is configured to move through slot 510 in a substantially longitudinal direction through receiving member 500. In addition, the placement of sliding member 550 inside slot 510 provides a redundant retention mechanism for receiving member 500 that helps to ensure long term robust operation. This occurs by ensuring that barb portion 522 is retained within slot 510.

In different embodiments, the type of fastening member used to secure sliding member 550 to linkage member 660 could vary. In some cases, for example, fastening member 650 could be a screw or nut/bolt type fastening member. In other cases, fastening member 650 could be a rivet. In particular, in embodiments where fastening member 650 is a rivet, fastening member 650 may include a substantially flat countersunk head portion 651 that is disposed against flange portion 562 of sliding member 550. In some cases, head portion 651 is larger than the narrower portion of slot 510. Moreover, flange portion 562 may be shaped to receive head portion 651 and thereby provide redundant security for the retention of receiving member 500. This arrangement may help to reinforce flange portion 562 and strengthen the overall connection of sliding member 550 to linkage member 660.

In some embodiments, by preassembling sliding member 550 and linkage member 660, the number of parts to be assembled by a customer can be reduced. This allows a customer to simply insert receiving member 500 into recess 620. In some cases, however, receiving member 500 may be preassembled within recess 620. Then, sliding member 550 and linkage member 660 can be inserted into slot 510. Moreover, receiving member 500 can be inserted into, and locked into place within, slot 510 in frame member 602 without requiring tools or further fasteners. Additionally, sliding member 550 can be inserted into receiving member 500, and retained within receiving member 500, without further need of tools or additional fasteners. This may help facilitate easy assembly for a user.

It will be understood that the arrangement discussed here can be used with any of the sliding assemblies discussed in the earlier embodiments. For example, first sliding assembly 171, second sliding assembly 172, third sliding assembly 173 and fourth sliding assembly 174 could each be configured in a similar manner to sliding assembly 600. Also, each of these sliding assemblies can be associated with recesses that are similar to recess 620. Moreover, while frame member 602 is illustrated in this embodiment as an outer frame member, a similar configuration may apply to sliding assemblies attached to an inner frame member.

The configurations discussed here and further below for a height adjustable assembly allow for dampened descent of a mattress frame that is smooth. Moreover, this configuration removes pinch points and substantially reduces and/or eliminates chatter that can occur in other types of sliding systems. This is achieved by using sliding members and receiving members that interact with substantially low friction. In some cases, low friction may be achieved through the use of low friction materials for a sliding assembly. Exemplary materials for different components of a sliding assembly are discussed in detail below.

Methods for making a height adjustable assembly can include provisions for improving the efficiency of manufacturing components associated with a sliding assembly. In some embodiments, a method can include steps for forming a recess in a frame member with varying cross-sectional widths in as few steps as possible. In one embodiment, a recess can be formed using a router bit having a variable cross-sectional area.

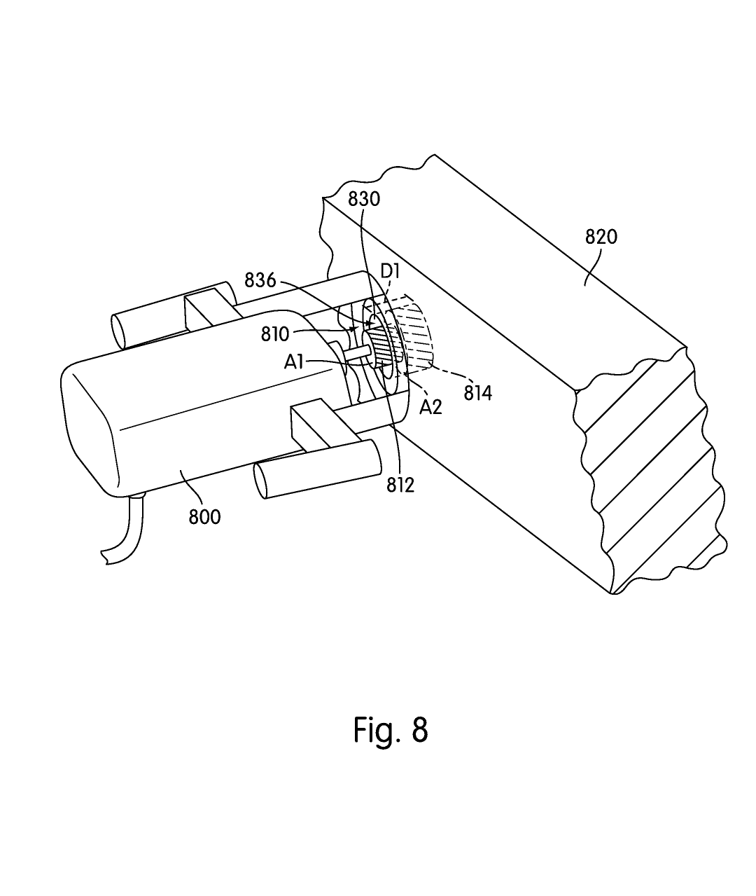

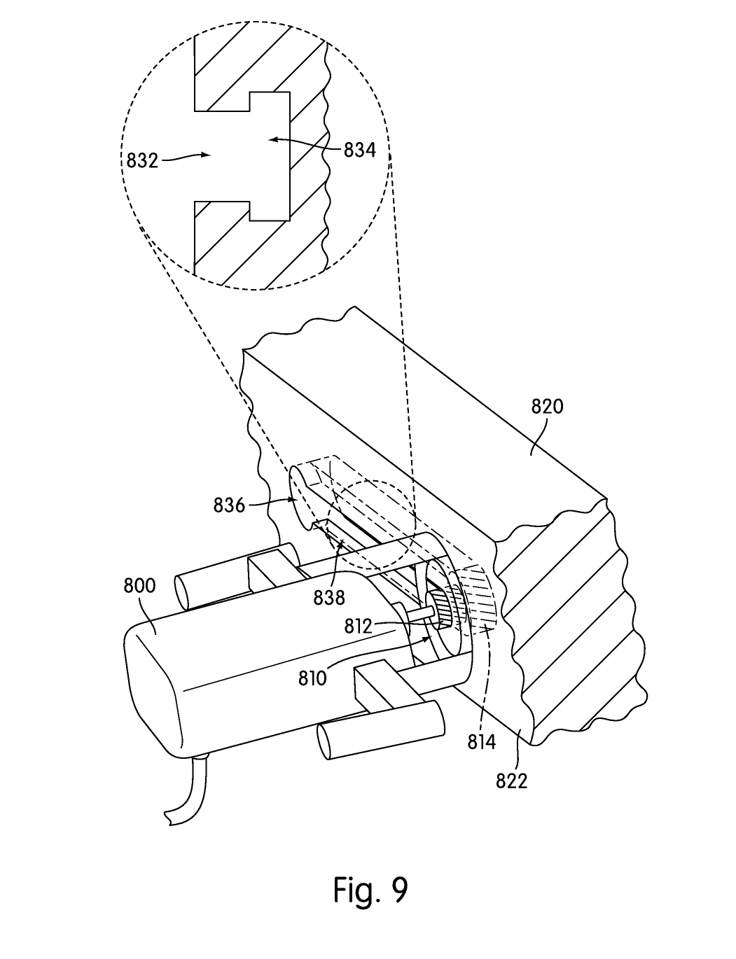

FIGS. 8 and 9 illustrate an embodiment of a method of forming a recess in a frame member. In some embodiments, drill 800 can be used to form a recess. Drill 800 could be any type of drill. In some cases, drill 800 could be a hand held drill. In other cases, drill 800 could be a hammer drill, a rotary drill, a drill press or any other kind of drill.

In some embodiments, drill 800 can be supplied with router bit 810. In some cases, router bit 810 can include proximal portion 812 and distal portion 814 that are disposed closer to, and further from, drill 800 respectively. In some cases, proximal portion 812 and distal portion 814 may be generally rounded portions. In some cases, for example, proximal portion 812 and distal portion 814 may have approximately circular cross-sectional areas. In other cases, however, proximal portion 812 and distal portion 814 could have any other cross-sectional areas including, but not limited to: triangular, rectangular, polygonal, regular, irregular as well as any other cross-sectional shapes.

In some embodiments, proximal portion 812 is configured with a first cross-sectional area A1. Likewise, distal portion 814 is configured with a second cross-sectional area A2. In one embodiment, second cross-sectional area A2 is substantially larger than first cross-sectional area A1. In other embodiments, the relative sizes of cross-sectional area A1 and cross-sectional area A2 could vary in any other manner.

During a first step in forming recess 830 within frame member 820, router bit 810 may be inserted into frame member 820 to a predetermined depth D1. The value of depth D1 could be selected according to the dimensions of a receiving member as well as the dimensions of a sliding member. In some embodiments, depth D1 is large enough so that proximal portion 812 of router bit 810 is disposed within recess 830. During this step, first portion 836 of recess 830 may be formed.

As seen in FIG. 9, a second step in forming recess 830 occurs when router bit 810 is moved through frame member 820 in a direction perpendicular to the direction in which router bit 810 was first inserted. In particular, router bit 810 may be moved within frame member 820 in a manner so that the depth of router bit 810 within frame member 820 remains approximately constant. In other words, router bit 810 may be moved in a direction approximately parallel with outer surface 822 of frame member 820. During this step, second portion 838 of recess 830 may be formed.

As router bit 810 moves through frame member 820, narrow portion 832 and wide portion 834 of recess 830 are formed substantially simultaneously. In particular, distal portion 814, which is wider than proximal portion 812, forms wide portion 834 of recess 830. Proximal portion 812 forms narrow portion 832. Once recess 830 has been fully formed, router bit 810 may be removed through the same path that was used for forming recess 830. This configuration allows for a relatively simple process for forming a recess with varying cross-sectional width.

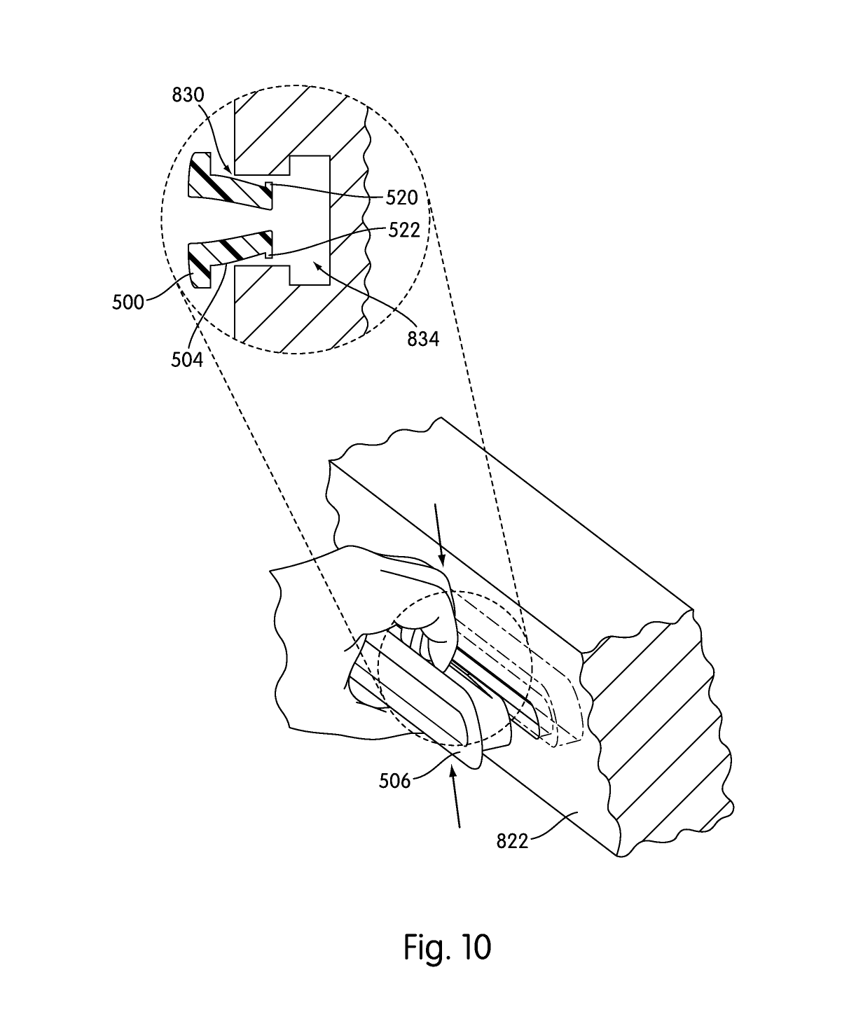

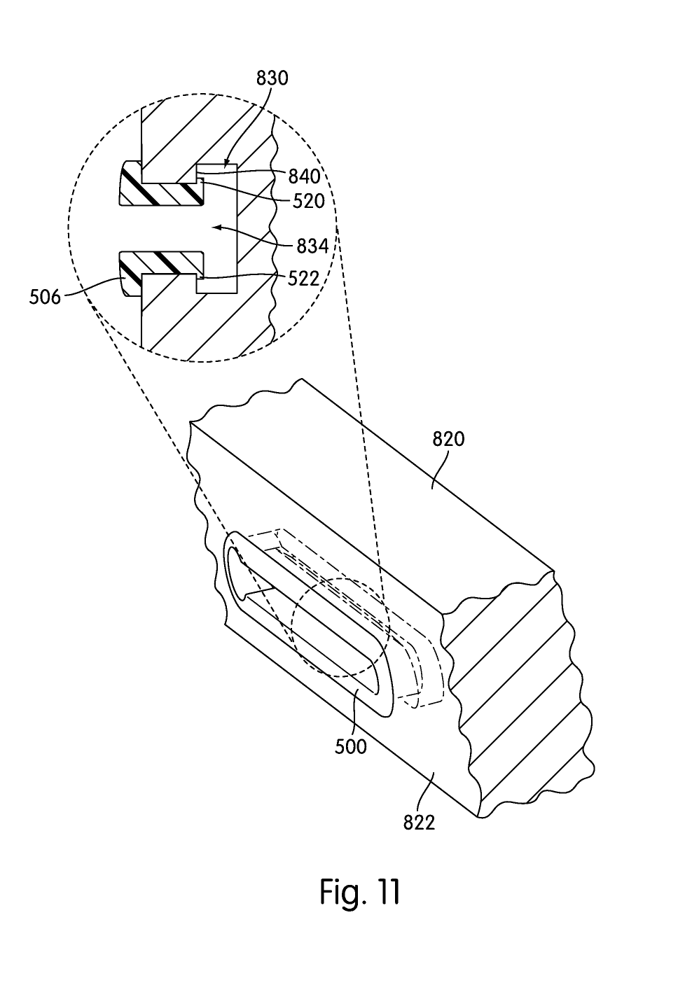

FIGS. 10 and 11 illustrate an embodiment of a process for assembling a receiving member with a frame member. Referring to FIGS. 10 and 11, a user may insert receiving member 500 into recess 830. In particular, to insert inward portion 504 of receiving member 500 through narrow portion 832 of recess 830, a user may squeeze inward portion 504 so that inward portion 504 is slightly compressed. This allows first barb portion 520 and second barb portion 522 to fit through narrow portion 832.

Next, a user may press receiving member 500 into recess 830 until inward portion 504 is fully inserted within recess 830 and flange portion 506 is flush with outer surface 822 of frame member 820. At this point, first barb portion 520 and second barb portion 522 may extend into wide portion 834 of recess 830. This allows first barb portion 520 and second barb portion 522 to catch against inner surface 840 of wide portion 834, which prevents receiving member 500 from being pulled back out of recess 830.

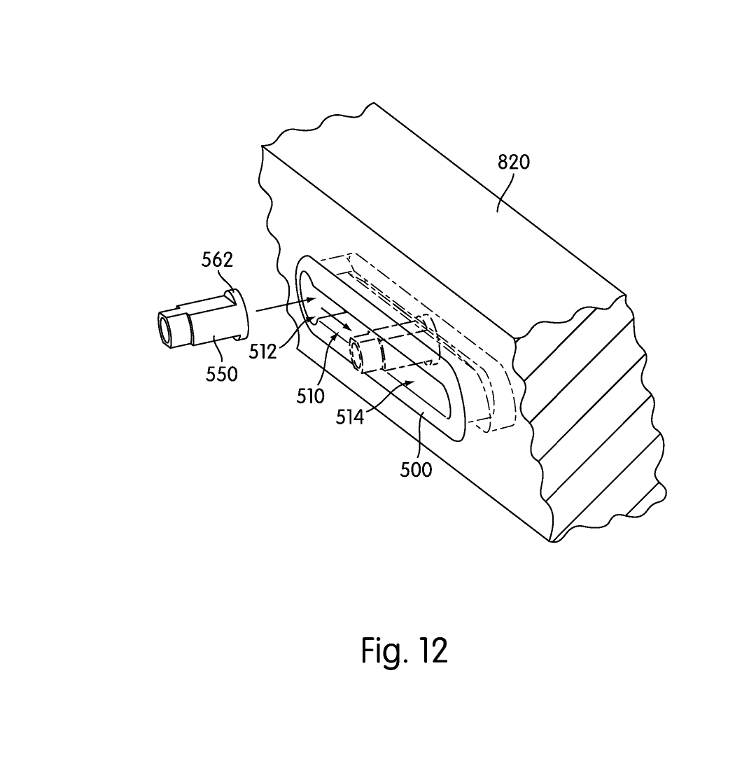

A final step of assembly, shown in FIG. 12, includes inserting sliding member 550 into receiving member 500. As previously discussed, the width of flange portion 562 is too large to fit into second portion 514 of slot 510. Therefore, sliding member 550 may be inserted at first portion 512 of slot 510 that is large enough to receive sliding member 550. Then, with sliding member 550 inserted into first portion 512, sliding member 550 may slide down to second portion 514 of slot 510. Following this, sliding member 550 may be fastened to a linkage member as discussed above.

In some embodiments, the connection between sliding member 550 and a linkage member may restrict the motion of sliding member 550 within receiving member 500. In some cases, for example, sliding member 550 may be prevented from moving into first portion 512 of slot 510. As long as sliding member 550 is disposed within second portion 514 of slot 510, sliding member 550 cannot be pulled out of receiving member 500 due to the presence of flange portion 562.

In different embodiments, the materials used for components of a height adjustable assembly may vary. In some embodiments, a frame member could be made of any material including, but not limited to: wood, metal, foam, plastic as well as any other durable materials. In embodiments where wood is used for one or more frame members, hard and/or soft woods could be used. Moreover, a frame member can be made from any material or combination of materials into which a recess can be formed.

In some embodiments, members of a linkage assembly could be made from any materials including metal, wood, plastic as well as any other suitable materials. In embodiments where metal is used, the members of the linkage assembly may be made of a substantially lightweight metal. In embodiments where plastic is used for members of a linkage assembly, a substantially rigid plastic may be used.

In some embodiments, components of a sliding assembly can be made from any materials including, but not limited to: metal, wood, rubber, plastic, as well as any other suitable materials. In some cases, for example, a receiving member could be made of a plastic. In addition, a sliding member could be made of a plastic. Moreover, the materials used for the receiving member and sliding member may be chosen with substantially low coefficients of friction so that the sliding member is easily moved through the receiving member. In some cases, the receiving member may comprise Nylon and the sliding member may be made of Acetal or vice versa. In other embodiments, however, any other materials could be used.

Materials for a receiving member and/or sliding member may be selected to achieve predetermined coefficients of dynamic and/or static friction. In some cases, the receiving member may have a low dynamic coefficient of friction in the range between 0 and 0.1. In other cases, the dynamic coefficient of friction of the receiving member could be greater than 0.1. In one embodiment, the dynamic coefficient of friction could be approximately 0.06. In addition, the receiving member can have a nearly matching static coefficient of friction in the range between 0 and 0.1. In other cases, the static coefficient of friction of the receiving member could be greater than 0.1. In one embodiment, the static coefficient of friction could be approximately 0.04 when sliding against a sliding member. In one embodiment, a receiving member and/or sliding member may also have a substantially low wear factor. This arrangement helps produce a silent and smooth sliding motion with minimal gap to maintain consistent horizontal mattress control.

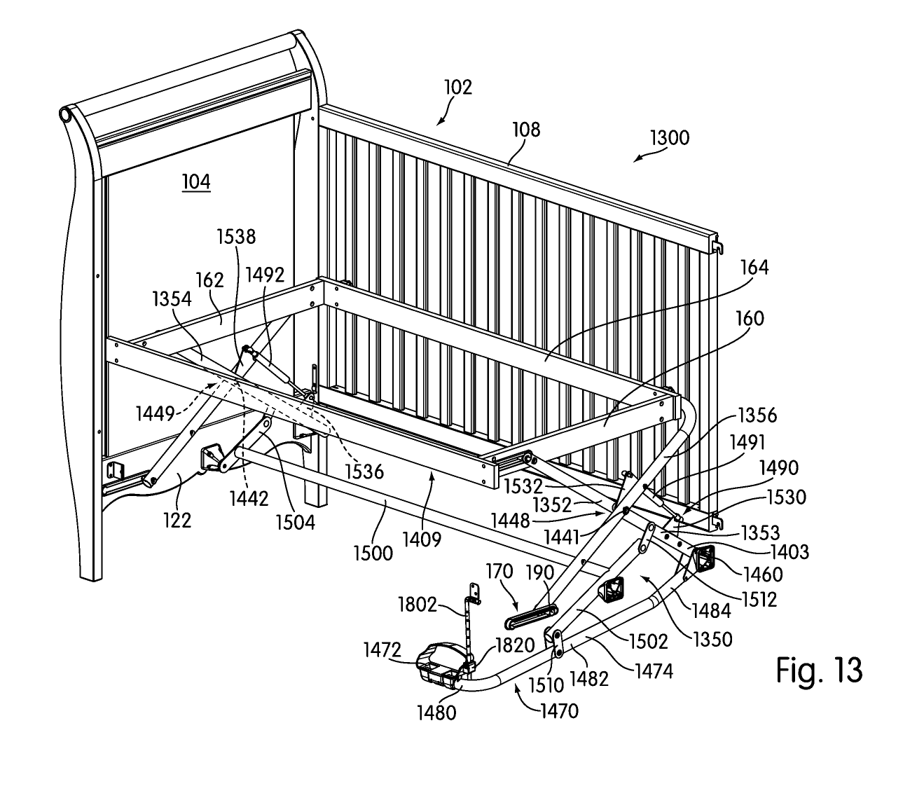

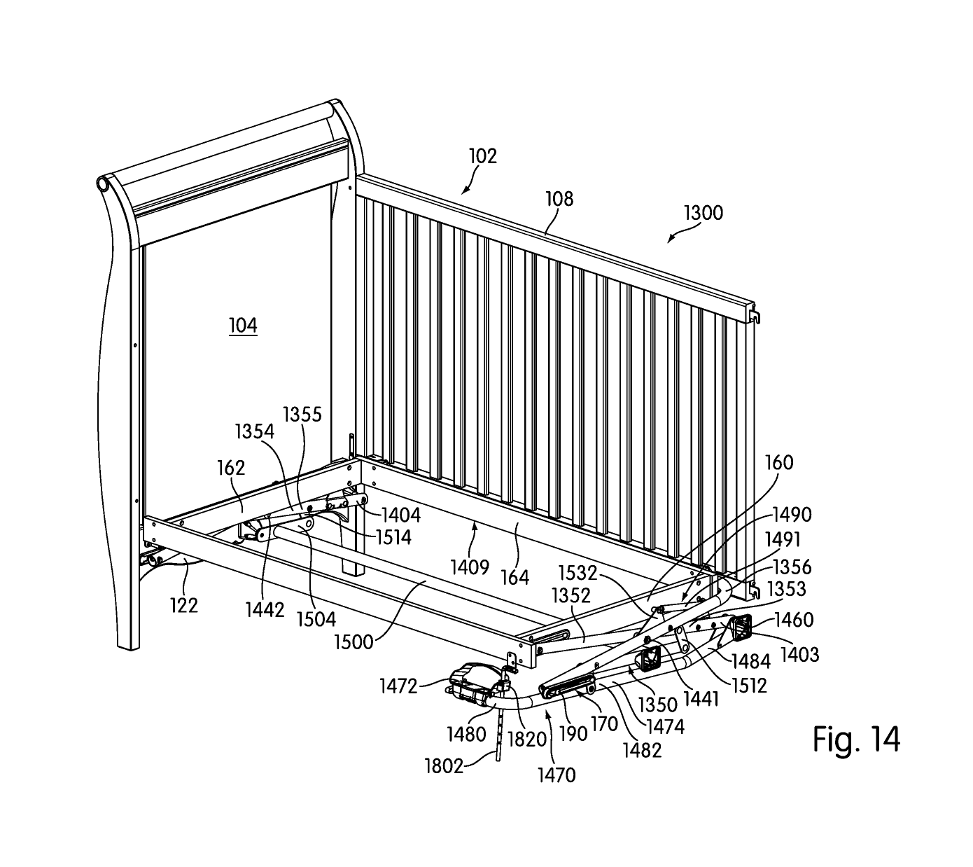

FIGS. 13 and 14 illustrate another embodiment of a height adjustable assembly 1300 in a raised position and a lowered position, respectively. Some of the components associated with height adjustable assembly 1300 are substantially similar to components associated with height adjustable assembly 100 (see FIGS. 1 and 2). For purposes of clarity, like numbers are used with like parts. For example, assembly 1300 may include outer support structure 102. For purposes of illustration, only some portions of outer support structure 102 are shown in the current embodiment (for example, first side panel 104, first rail 108 and first outer frame member 122). This allows for a relatively clear view of the basic components of assembly 1300.

Assembly 1300 may also include inner frame member 140. Inner frame member 140 may be a separate component from outer support structure 102. In embodiments where assembly 1300 is associated with a crib, inner frame member 140 may comprise a frame for supporting a mattress or any other kind of bedding surface. Moreover, inner frame member 140 may be disposed within outer support structure 102 and supported by outer support structure 102.

Assembly 1300 can include provisions that allow inner frame member 140 to move with respect to outer support structure 102. For example, in some cases, outer support structure 102 is configured to remain stationary while inner frame member 140 moves in a vertical direction within outer support structure 102.

In some embodiments, inner frame member 140 may be attached to outer support structure 102 using linkage assembly 1350. Linkage assembly 1350 may include first linkage member 1352, second linkage member 1354 and third linkage member 1356. First linkage member 1352 is associated with first side 160 of inner frame member 140 and second linkage member 1354 may be associated with second side 162 of inner frame member 140. In addition, third linkage member 1356 may be associated with rear side 164 of inner frame member 140.

Linkage assembly 1350 may be similar to linkage assembly 150 of the previous embodiments in some respects, but not others. In particular, first linkage member 1352, second linkage member 1354 and third linkage member 1356 may be slidably connected to sliding assemblies 170 in a similar manner to the connection of first linkage member 152, second linkage member 154 and third linkage member 156 to sliding assemblies 170 (see FIGS. 1 and 2).

The components of linkage assembly 1350 and sliding assemblies 170 can be attached in a variety of different ways. FIGS. 13 and 14 illustrate one possible arrangement for securing these components together. For example, first fastener 1441 and second fastener 1442 may be used to connect first linkage member 1352 and second linkage member 1354, respectively, to third linkage member 1356. In some cases, first fastener 1441 and second fastener 1442 may be nut and bolt type fasteners. In the current embodiment, first fastener 1441 and second fastener 1442 may be rivet type fasteners. In some embodiments, first linkage member 1352, second linkage member 1354 and third linkage member 1356 may be factory assembled using various rivets. It will be understood that in other embodiments, any other kinds of fasteners may be used to connect first linkage member 1352, second linkage member 1354 and third linkage member 1356.

Furthermore, in some cases, sliding fasteners are used to secure sliding members 190 to linkage assembly 1350. In some cases, the sliding fasteners may be rivets. In other cases, however, other kinds of fasteners could be used including, but not limited to: screws, nut and bolt fasteners, wire clip fasteners, as well as any other kinds of fasteners. In some embodiments, linkage members and sliding members could be factory assembled using various rivets.

In some embodiments, end 1403 of first linkage member 1352 and end 1404 of second linkage member 1354 can be secured directly to first outer frame member 120 and second outer frame member 122 (see FIG. 1), respectively. In some cases, end 1403 may be secured using first bracket 1460. Also, in some cases, end 1404 may be secured using a bracket (not shown). First bracket 1460 can be secured to outer support structure 102 using any types of fasteners. In some cases, fastening pins may be used to secure first bracket 1460 to outer support structure 102. Likewise, end 1404 could be secured to outer support structure 102 using any type of fasteners including fastening pins. In other cases, first linkage member 1352 and second linkage member 1354 could be secured directly to first outer frame member 120 and second outer frame member 122 (or any other portions of support structure 102) without the use of any intermediate brackets. In such cases, any types of fasteners could be used including nut and bolts, screws, rivets, pins as well as any other kinds of fasteners.

Referring to FIGS. 13 and 14, assembly 1300 includes pedal assembly 1470 for raising and lowering linkage assembly 1350. Pedal assembly 1470 includes pedal 1472 and pedal linkage member 1474. End 1480 of pedal linkage member 1474 may be attached to pedal 1472. Moreover, in contrast to the previous embodiments, end 1484 of pedal linkage member 1474 is attached to first bracket 1460, which is disposed at a rearmost location of linkage assembly 1350. Using this arrangement, the center point of the arc of the pedal is located as far back as possible along the assembly.

Assembly 1300 can include cross bar member 1500 that extends along the length of outer support structure 102 and which facilitates the operation of pedal assembly 1470. In particular, cross bar member 1500 includes first connecting member 1502 that connects intermediate portion 1482 of pedal linkage member 1474 with intermediate portion 1353 of first linkage member 1352. In addition, cross bar member 1500 includes second connecting member 1504 that connects outer frame member 122 to intermediate portion 1355 of second linkage member 1354. Using this arrangement, as pedal 1472 is pressed downward first connecting member 1502 applies a force on first linkage member 1352 that acts to raise linkage assembly 1350. This causes cross bar member 1500 to rotate so that second connecting member 1504 applies a similar force to second linkage member 1354, which facilitates raising linkage assembly 1350.

In some cases, first connecting member 1502 may be connected to pedal linkage member 1474 and first linkage member 1352 using bracket 1510 and bracket 1512, respectively. Likewise, second connecting member 1504 may be connected to second linkage member 1354 using bracket 1514. In some cases, rivet type fasteners may be used to secure bracket 1510, bracket 1512 and bracket 1514 to their respective components. In other cases, any other types of fasteners could be used.

It will be understood that any types of fasteners may be used for securing various different components together. In some cases, a fastener could comprise a bolt with a nut. In other cases, a fastener could include screws, nails, pins, rivets or any other kinds of fasteners known in the art. In particular, each fastener may be selected according to the specific features of the components being connected. In embodiments where assembly 1300 is configured to be assembled by a customer or user, the fasteners could be selected to provide increased ease of assembly.

In some cases, some fasteners may provide a pivoting connection between two or more components. For example, first fastener 1441 may facilitate a first pivoting connection 1448 between first linkage member 1352 and third linkage member 1356. Likewise, second fastener 1442 may facilitate a second pivoting connection 1449 between second linkage member 1354 and third linkage member 1356. In other cases, some fasteners may fasten two components in a manner that restricts or prevents any relative rotation or movement.

Assembly 1300 can include strut system 1490. Strut system 1490 includes first strut 1491 and second strut 1492. First strut 1491 may be associated with first linkage member 1352 and third linkage member 1356. In some cases, first strut bracket 1530 is used to secure first strut 1491 to intermediate portion 1353 of first linkage member 1352. Likewise, second strut bracket 1532 is used to secure first strut 1491 to first pivoting connection 1448.

Second strut 1492 may be associated with second linkage member 1354 and third linkage member 1356. In some cases, third strut bracket 1536 is used to secure second strut 1492 to second linkage member 1354. Likewise, fourth strut bracket 1538 is used to secure second strut 1492 to second pivoting connection 1449.

This arrangement provides a configuration in which first strut 1491 and second strut 1492 are approximately parallel with first linkage member 1352 and second linkage member 1354, respectively. This may facilitate increased damping and lifting assistance by strut system 1490. It will be understood, however, that the particular locations of first strut 1491 and second strut 1492 shown in the Figures are only intended to be exemplary. In other embodiments, the locations of each strut could vary in order to modify the mechanical advantage provided by strut system 1490 in operating linkage assembly 1350. Furthermore, while the current embodiment includes two distinct struts, in other embodiments a single strut could be used in combination with a pedal assembly.

In different embodiments, various different kinds of struts could be used. In some cases, pneumatic struts could be used. For example, in one embodiment gas struts could be used. In other cases, any other kinds of struts known in the art may be used. In some embodiments the type of strut may be selected according to the amount of force required to facilitate the operation of a height adjustable assembly.

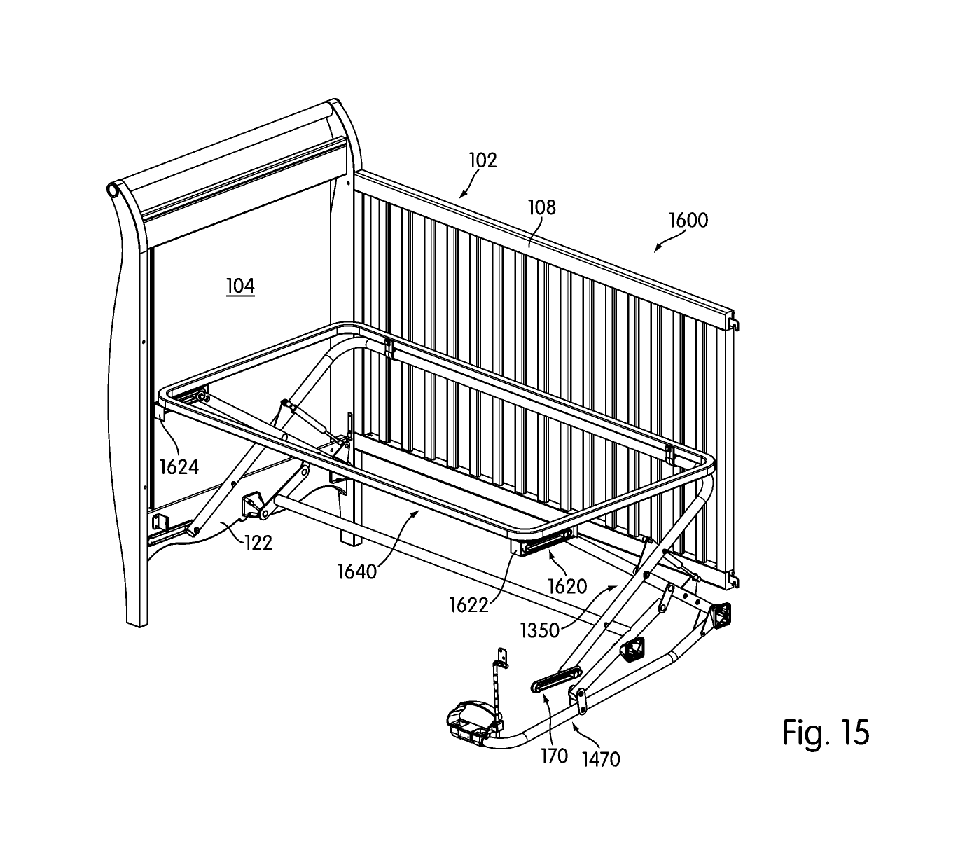

FIG. 15 illustrates an isometric view of another embodiment for a height adjustable assembly 1600. Some of the components associated with height adjustable assembly 1600 are substantially similar to components associated with height adjustable assembly 1300 of the previous embodiment. For purposes of clarity, like numbers are used with like parts. For example, assembly 1600 may include outer support structure 102. For purposes of illustration, only some portions of outer support structure 102 are shown in the current embodiment (for example, first side panel 104, first rail 108 and first outer frame member 122). This allows for a relatively clear view of the basic components of assembly 1600. Additionally, assembly 1600 includes a substantially similar linkage assembly 1350 to the previous embodiment, as well as a substantially similar pedal assembly 1470.

In contrast to the previous embodiment, assembly 1600 includes inner frame 1640. In some cases, inner frame 1640 may be made of a material that cannot be easily drilled, cut or routed. Examples of such materials include, but are not limited to: metal, plastic, composite materials as well as any other materials. In one embodiment, inner frame 1640 may comprise a metal material.

In order to accommodate sliding assemblies 170, assembly 1600 may further comprise bracket system 1620. Bracket system 1620 includes first bracket 1622 and second bracket 1624. Each bracket of bracket system 1620 may be mounted to inner frame member 1640 and configured to receive corresponding receiving members of sliding assemblies 170.

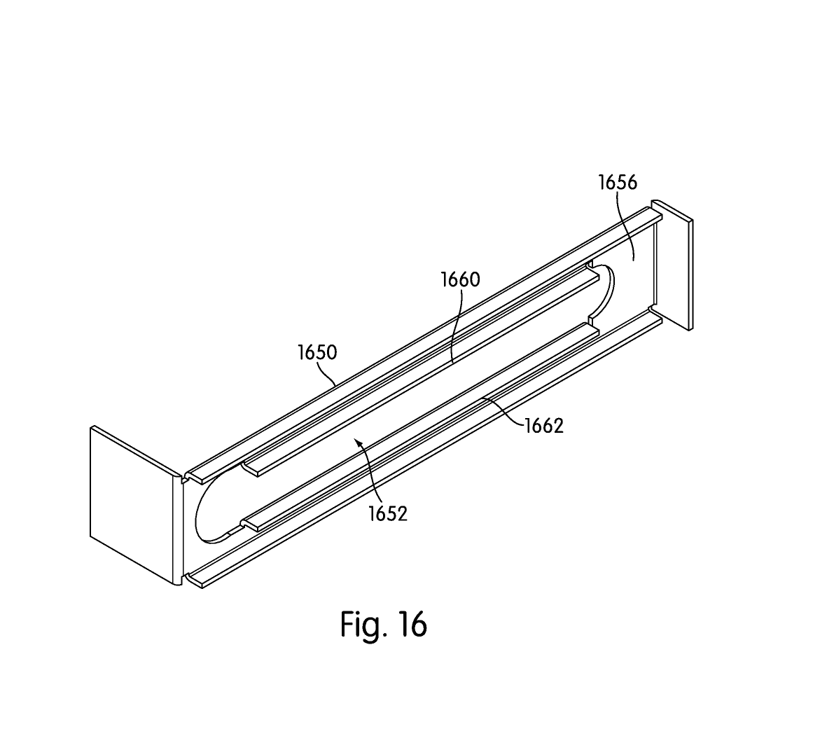

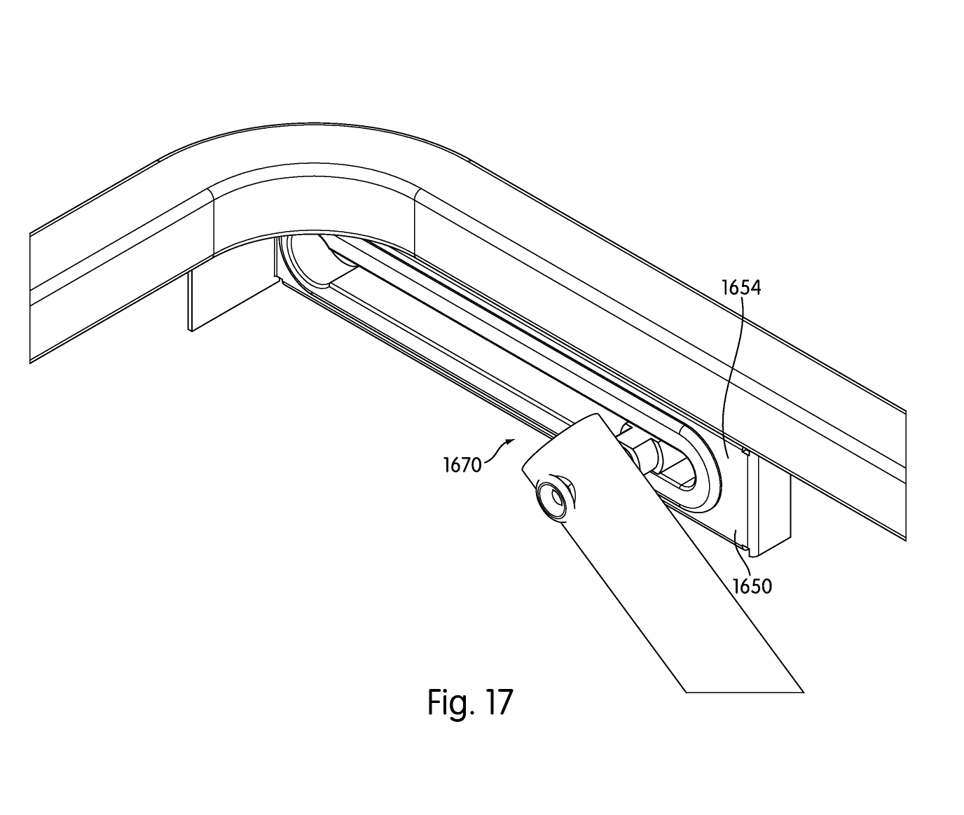

FIGS. 16 and 17 illustrate isometric views of an exemplary bracket 1650 and sliding assembly 1670. In this case, bracket 1650 comprises a substantially rigid bracket that includes slot 1652. First side 1654 of bracket 1650 is substantially flat. In contrast, second side 1656 of bracket 1650 includes first flange 1660 and second flange 1662. In some cases, first flange 1660 and second flange 1662 may be engaged by barbed portions of sliding assembly 1670. With this configuration, first flange 1660 and second flange 1662 provide a narrow portion that can receive part of sliding assembly 1670, while the barbed portions of sliding assembly 1670 are configured to wrap around the edges of first flange 1660 and second flange 1662.

In embodiments where various components are preassembled using rivets or other types of fasteners, general assembly of the various height adjustable assemblies discussed above may proceed as follows. In particular, the following steps may occur for a configuration where an inner mattress frame is already preassembled with a linkage assembly and/or pedal assembly. For reference, the following steps are discussed for the particular embodiment shown in FIGS. 13 and 14, however it will be understood that similar steps could be performed for other types of configurations. In a first step, sliding members attached to the ends of third linkage member 1356 are inserted into the corresponding receiving members already installed in outer support structure 102. In a second step, linkage assembly 1350 and pedal assembly 1470, which may comprise a single sub assembly, are moved into a position so that first linkage member 1352 and second linkage member 1354 can be assembled with outer support structure 102. In a third step, lower rear pivot pins are used to connect first linkage member 1352 and second linkage member 1354 to outer support structure 102, either directly or via brackets that facilitate pivoting. This method facilitates ease of assembly by reducing the number of parts required to be connected and by removing the need for tools. Furthermore, the number of fasteners is minimized.

A height adjustable assembly can include provisions for locking the assembly into place. In some cases, a pedal assembly could be provided with a locking system of some kind. For example, in some cases, a latch type locking system could be used. In other cases, other types of locking systems could be used. In some cases, a locking system can be utilized that provides for a variety of positions for the height adjustable assembly.

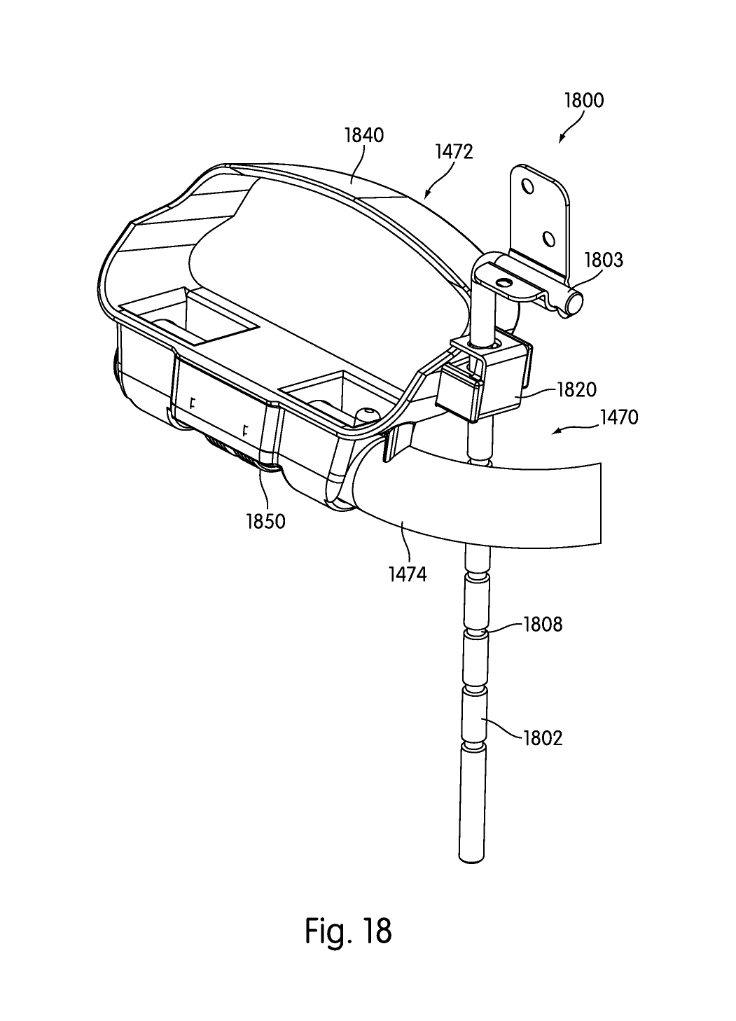

FIG. 18 illustrates an enlarged isometric view of pedal assembly 1470 including a locking system 1800. Locking system 1800 comprises locking portion 1820 and rod 1802. A perpendicular end 1803 of rod 1802 is fixedly attached to bracket 1804. Bracket 1804 may be further mounted to a portion of outer support structure 102 (see FIG. 13). In some cases, rod 1802 may be free to rotate with respect to bracket 1804. In addition, rod 1802 may be provided with notches 1808 that are spaced apart along the length of rod 1802.

In some cases, pedal 1472 may be mounted to pedal linkage 1474 using spring 1850. Spring 1850 may be configured to bias pedal 1472 towards a forwardly rotated position. This allows pedal 1472 to be rotated about pedal linkage 1474. Because pedal 1472 includes top portion 1840 that may surround the top of a foot, a user can rotate pedal 1472 by lifting upwards on pedal 1472.

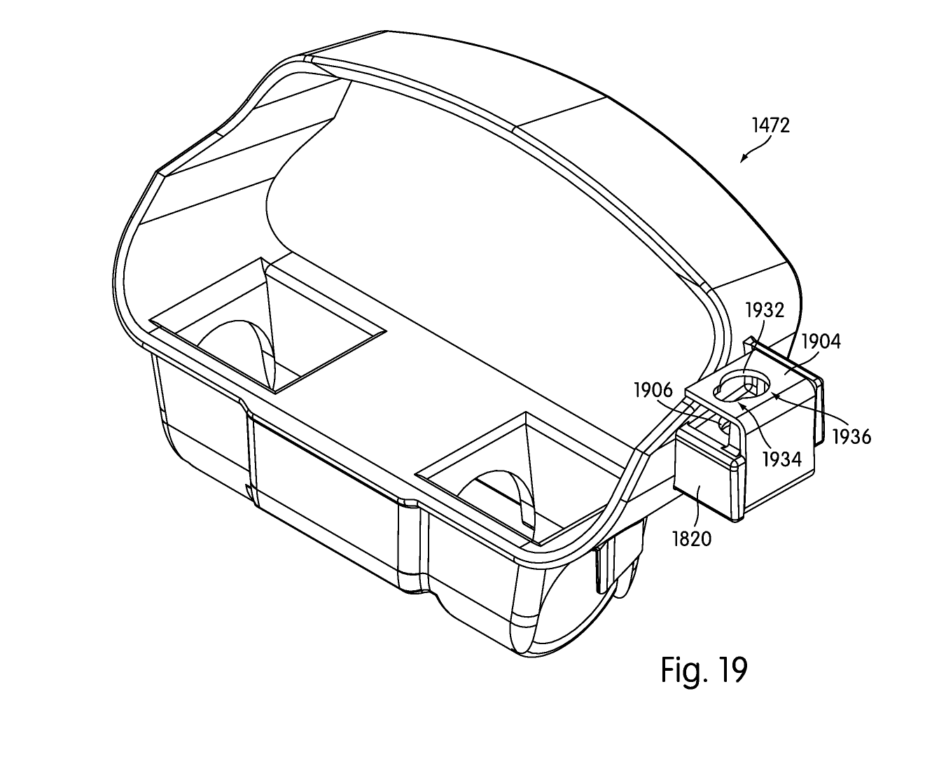

Referring now to FIG. 19, locking portion 1820 extends off from the side of pedal 1472 and can include recess 1906. Locking portion 1820 is further associated with clip 1904. In some cases, clip 1904 includes locking slot 1932. Locking slot 1932 comprises first portion 1934 and second portion 1936. In some cases, second portion 1934 is has a substantially larger cross sectional area than first portion 1934.

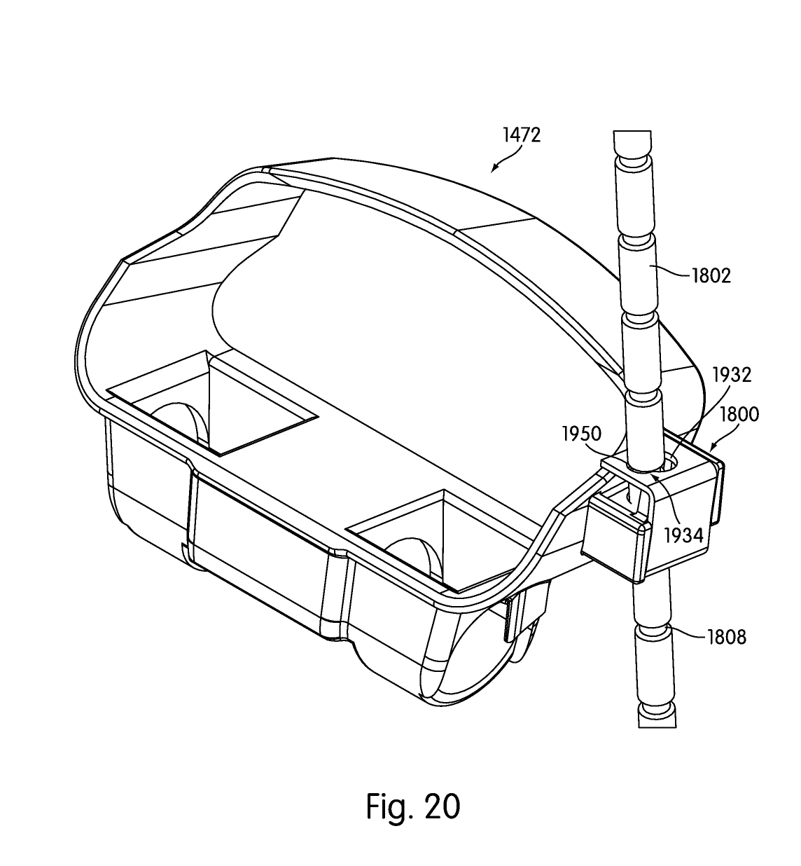

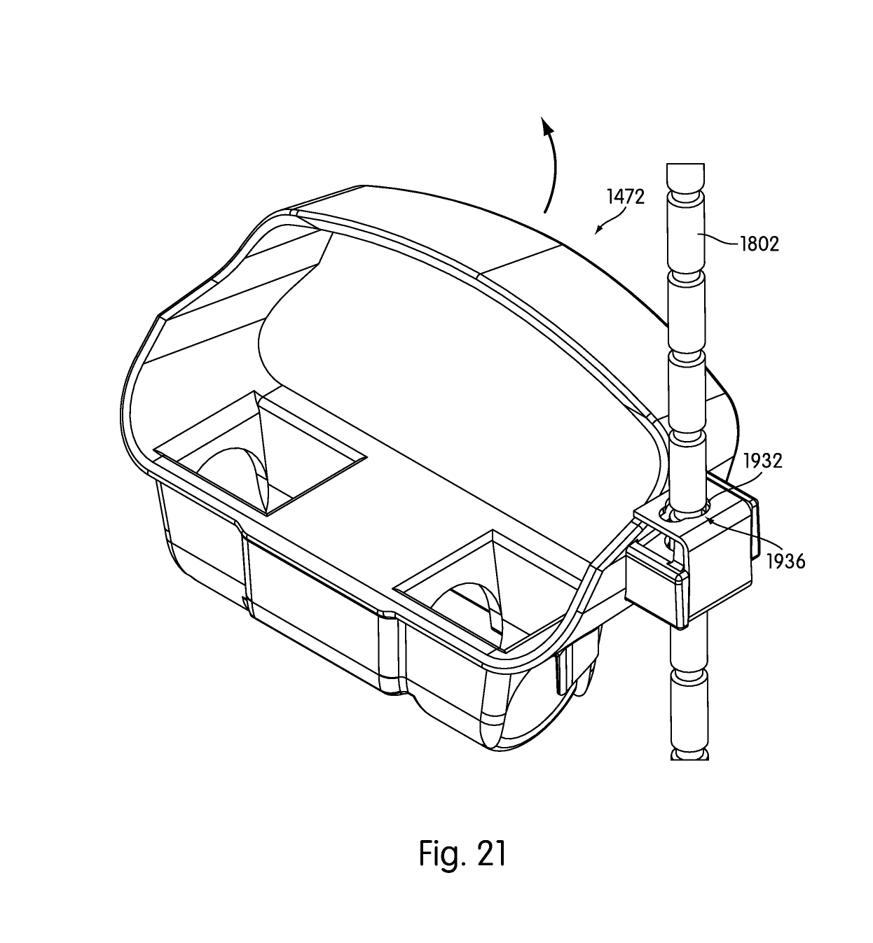

For purposes of illustration, pedal 1472 and rod 1802 are shown in isolation from pedal assembly 1470 in FIGS. 20 and 21. In the locked state, shown in FIG. 20, rod 1802 is disposed within first portion 1934 of locking slot 1932. In particular, first portion 1934 is engaged with notch 1950 of rod 1802. Moreover, spring 1850 (see FIG. 18) ensures that pedal 1472 is biased in a direction to prevent rod 1802 from slipping out of first portion 1834. To unlock rod 1802, as seen in FIG. 21, pedal 1472 may be rotated upwards, so that rod 1802 is disposed in second portion 1936 of locking slot 1932. Then pedal 1472 can be moved vertically with respect to rod 1802, as the height of assembly 1600 is changed. The height of assembly 1600 can be fixed by reengaging rod 1802 within first portion 1934 of locking slot 1932.

Referring back to FIGS. 13 and 14, pedal 1472 is shown in two different locked positions. In a first locked position, seen in FIG. 13, pedal 1472 is in a position so that the lowest notch of rod 1802 is engaged by locking portion 1820. This position corresponds to the fully raised position of frame member 140. In a second locked position, seen in FIG. 14, pedal 1472 is in a position so that the highest notch of rod 1802 is engaged by locking portion 1820. This position corresponds to the fully lowered position of frame member 140. Moreover, the intermediate notches of rod 1802 allow pedal 1472 to be locked into place at a variety of different positions along rod 1802. These different locking positions provide for a variety of different adjustable heights for frame member 140 and an associated mattress.

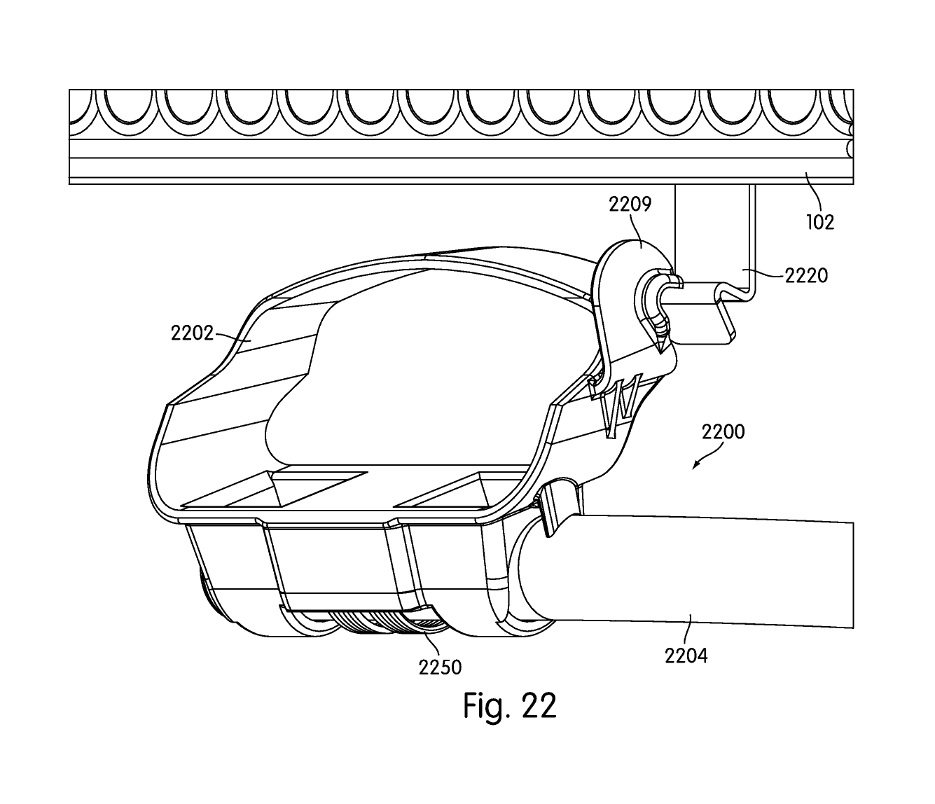

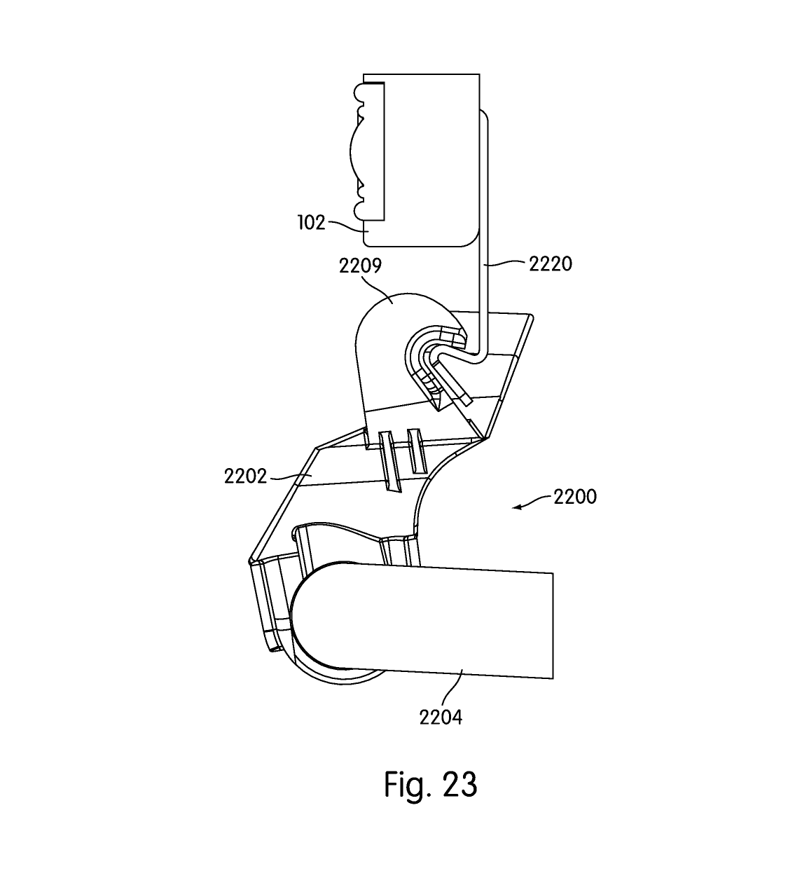

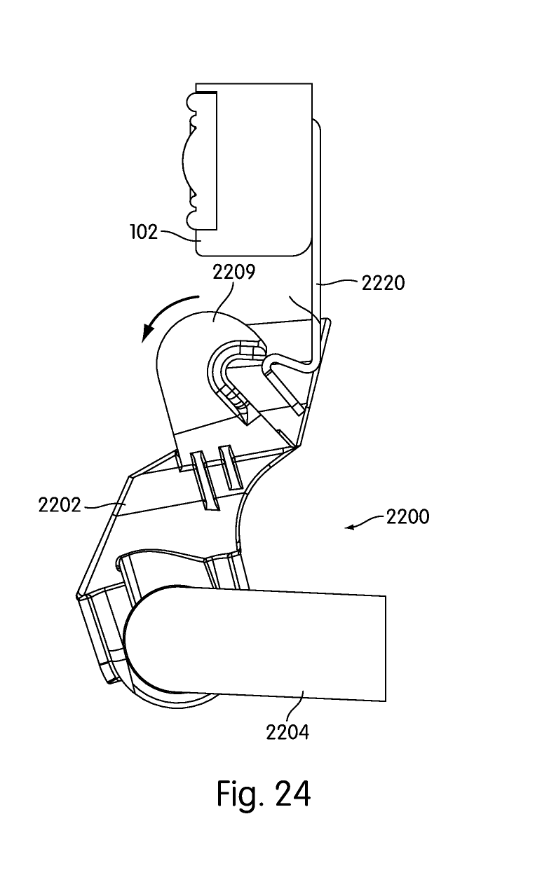

FIG. 22 illustrates an isometric view of another embodiment of a locking system for pedal assembly 2200. FIGS. 23 and 24 illustrate side views of a locking system for pedal assembly 2200 in locked and unlocked positions, respectively. Referring to FIGS. 22 through 24, pedal 2202 may be mounted to pedal linkage 2204 using spring 2250, as discussed above. The spring may be configured to bias pedal 2202 towards a forwardly rotated position.

Pedal 2202 further includes engaging portion 2209 that can be configured to engage latch 2220. Engaging portion 2209 may be a hook-like structure that wraps around a portion of latch 2220. In some cases, latch 2220 may be mounted directly to outer support structure 102. When a linkage assembly is in a closed, or lowered, position, pedal 2202 is raised and disposed adjacent to latch 2220. Moreover, pedal 2202 is normally biased towards the forwardly rotated position so that engaging portion 2209 engages latch 2220. This prevents pedal 2202 from being depressed as latch 2220 is locked into place.

As seen in FIG. 24, pedal 2202 can be disengaged from latch by rotating pedal upwardly so that engaging portion 2209 is removed from latch 2220. This allows a user to depress pedal 2202 and thereby raise the mattress bed.

These various locking systems are not limited to use with a particular configuration for a height adjustable assembly. In particular, both a latch-type locking system and a rod type locking system could be used with any of the various configurations discussed throughout this detailed description for a height adjustable assembly. In other embodiments, a locking system may be optional. In still other embodiments any other kinds of locking systems known in the art could be used.

These configurations for locking systems help to improve the safety of a height adjustable assembly. For example, the locking system may prevent siblings of a baby or toddler from moving the mattress frame. In addition, the locking system may prevent a child from self-raising the bed if the child does a pull up on the top bed rail.

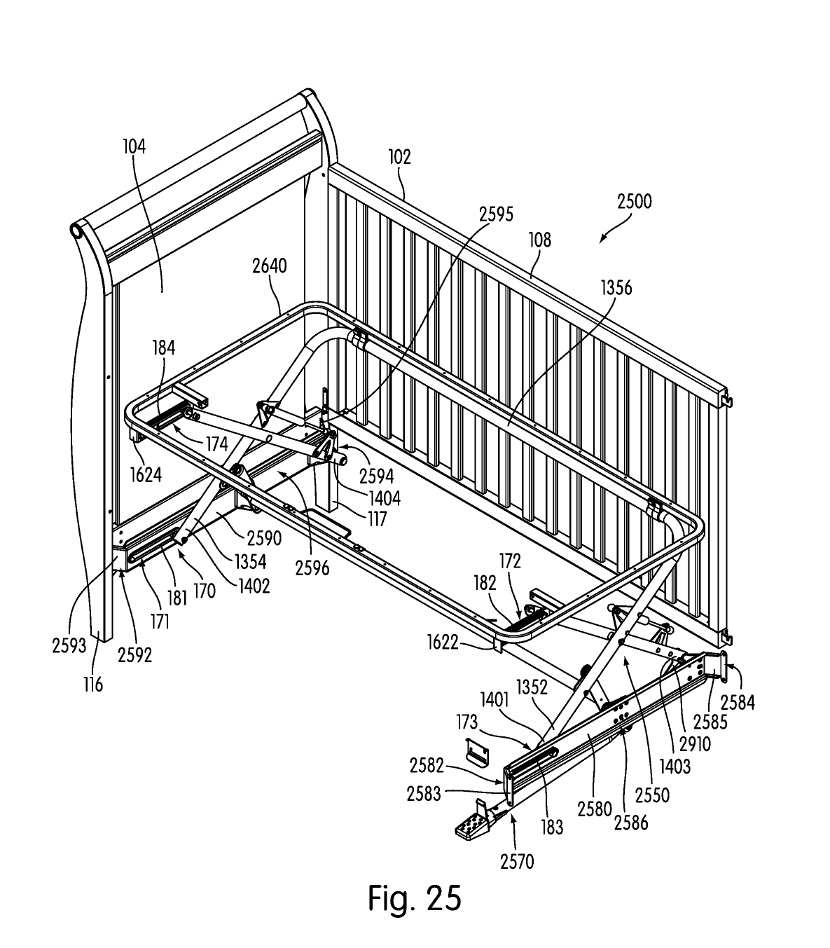

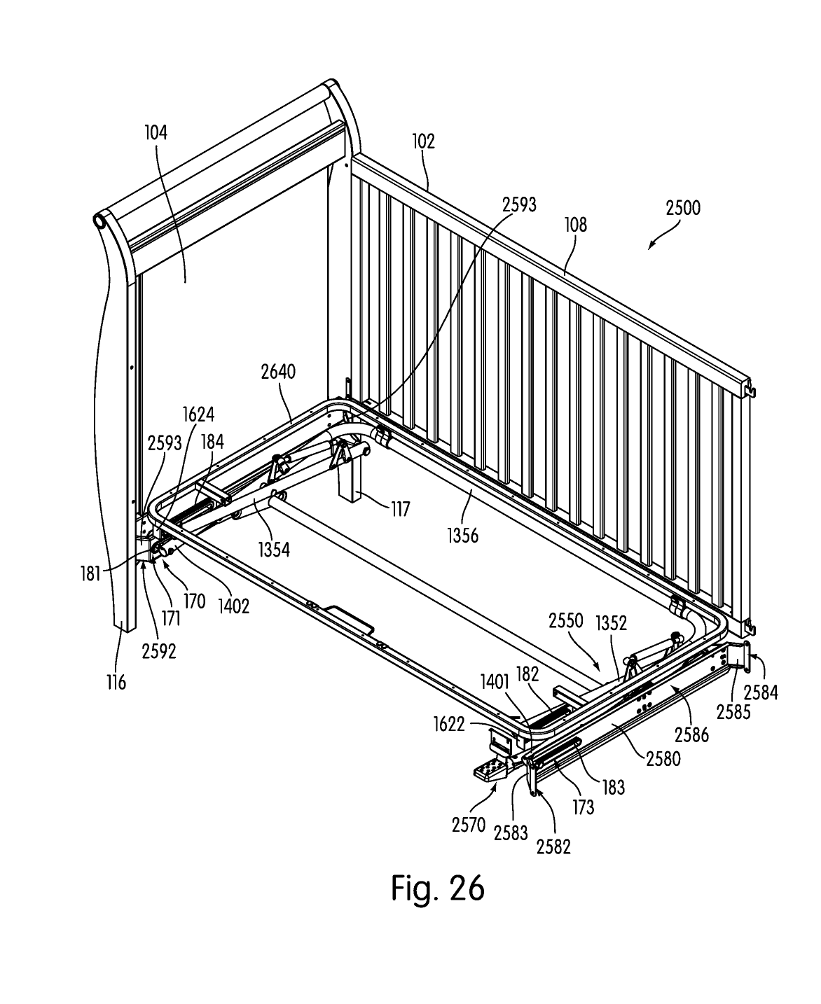

FIGS. 25 and 26 illustrate views of an alternative embodiment of an adjustable assembly 2500 in a raised position and a lowered position, respectively. Some of the components associated with height adjustable assembly 2500 are substantially similar to components associated with height adjustable assembly 100 and height adjustable assembly 1300 (see FIGS. 1, 2, 13 and 14). For purposes of clarity, like numbers are used with like parts. For example, assembly 2500 may include outer support structure 102. For purposes of illustration, only some portions of outer support structure 102 are shown in the current embodiment (for example, first side panel 104 and first rail 108). This allows for a relatively clear view of the basic components of assembly 2500.

In some embodiments, assembly 2500 may include linkage assembly 2550. In some cases, assembly 2500 can also include pedal assembly 2570. In some cases, pedal assembly 2570 may be used to raise and lower linkage assembly 2550. A detailed description of the operation of pedal assembly 2570 and linkage assembly 2550 are discussed in detail below.

In some embodiments, assembly 2500 can include inner frame 2640. In some cases, inner frame 2640 may be made of a relatively rigid material. Examples of such materials include, but are not limited to: metal, plastic, composite materials as well as any other materials. In other cases, inner frame 2460 could be made of materials, such as wood, that could be easily drilled, cut or routed. Inner frame 2640 may be configured to support a mattress or other bedding surface.

In some embodiments, assembly 2500 may include sliding assemblies 170 that provide a sliding connection between inner frame 2640 and linkage assembly 2550. In some cases, sliding assembly 174 and sliding assembly 172 may provide sliding connections between inner frame 2640 and linkage assembly 2550. In some cases, receiving portion 184 of sliding assembly 174 and receiving portion 182 of sliding assembly 172 are engaged with second bracket 1624 and first bracket 1622, respectively.

An adjustable assembly can include provisions for preventing a linkage assembly from interfering with any components that hang down from the edges of a mattress frame. As an example, an adjustable assembly may include provisions to prevent a linkage assembly from interfering with crib skirts. In some cases, an adjustable assembly can include provisions to mount a linkage assembly to the legs or posts of an outer frame. In some cases, this could be accomplished using a mounting rail that mounts to the legs of an outer frame and provides a sliding connection for the adjustable assembly.

Referring now to FIGS. 25 through 27, in some embodiments, adjustable assembly 2500 may include first mounting rail 2580 and second mounting rail 2590 (see FIG. 25). First mounting rail 2580 may include first end portion 2582, second end portion 2584 and intermediate portion 2586. In some cases, first end portion 2582 includes flanged portion 2583 that may be configured to mount to first leg 114 (see FIG. 1) of outer support structure 102. Likewise, in some cases, second end portion 2584 includes flanged portion 2585 that may be configured to mount to second leg 115 (see FIG. 1) of outer support structure 102. Moreover, in some cases, second mounting rail 2590 may include first end portion 2592, second end portion 2594 and intermediate portion 2596. In some cases, first end portion 2592 includes flanged portion 2593 that may be configured to mount to third leg 116 of outer support structure 102. Likewise, in some cases, second end portion 2594 includes flanged portion 2595 that may be configured to mount to a fourth leg 117 of outer support structure 102.

In some cases, a flanged portion can be angled with respect to an intermediate portion of a mounting rail. For example, in some cases, flanged portion 2583, flanged portion 2585, flanged portion 2593 and flanged portion 2595 may be angled portions of mounting rail 2580 and mounting rail 2590. This configuration allows first mounting rail 2580 and second mounting rail 2590 to be suspended between the legs of outer support structure 102. Furthermore, this arrangement allows intermediate portion 2586 and intermediate portion 2596 of mounting rail 2580 and mounting rail 2590, respectively, to be spaced inwardly of outer frame 102.

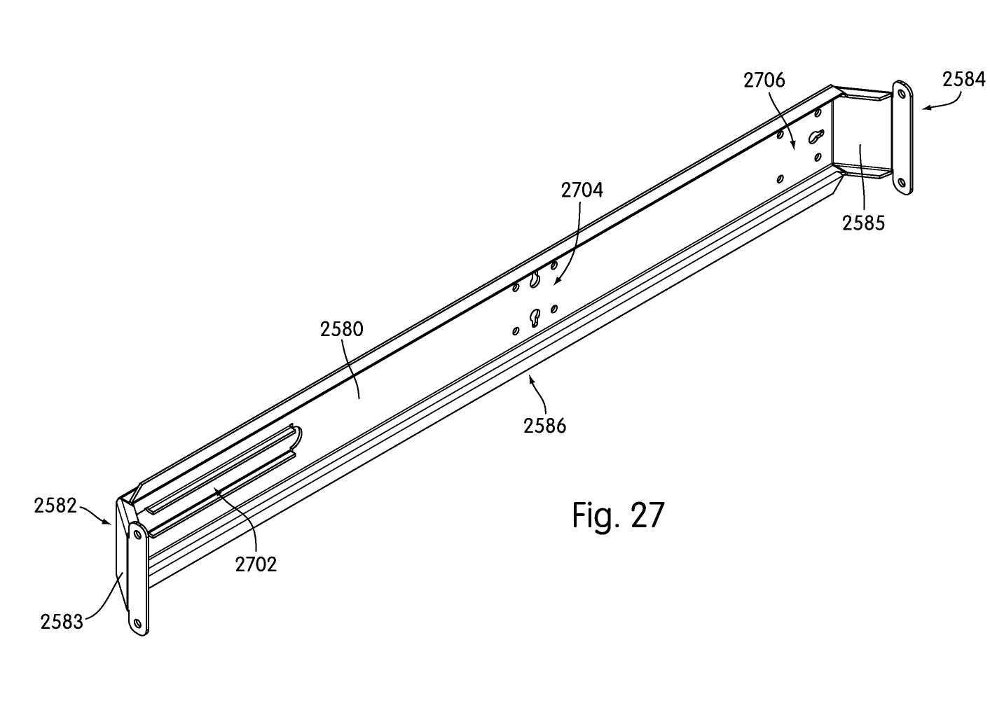

Each mounting rail can include provisions for receiving components of sliding assemblies 170 and linkage assembly 2550. Referring to FIG. 27, in some cases, first mounting rail 2580 includes slot portion 2702 for engaging receiving member 183 of sliding assembly 173. In some cases, first mounting rail 2580 also includes central mounting portion 2704 and rear mounting portion 2706 for pivotally connecting to portions of linkage assembly 2550, as discussed in further detail below. In a similar manner, second mounting rail 2590 can include a corresponding slot and mounting portions to receive portions of sliding assembly 171 and linkage assembly 2550.

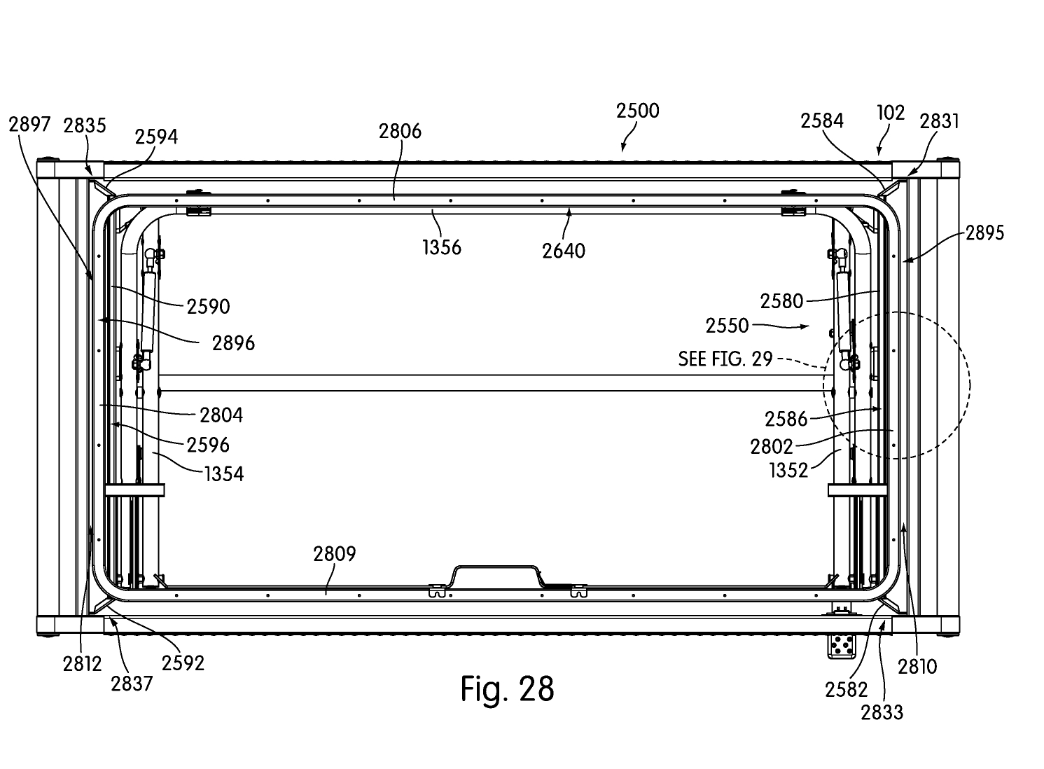

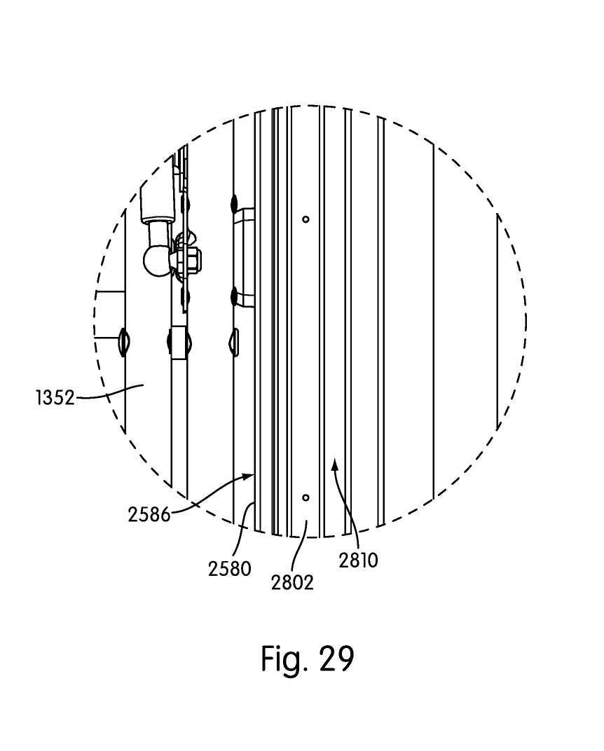

FIG. 28 illustrates a schematic top down view of adjustable assembly 2500. FIG. 29 illustrates an enlarged view of a portion of adjustable assembly. As seen in FIG. 28, mounting rail 2580 and mounting rail 2590 provide means for suspending linkage assembly 2550 inwardly from outer support structure 102. For example, in one embodiment, first end portion 2582 and second end portion 2584 may be attached to first corner 2831 and second corner 2833, respectively, of outer support structure 102. Additionally, intermediate portion 2586 of mounting rail 2580 may be spaced inwardly from first edge 2802 of inner frame 2640. In other words, mounting rail 2580 is attached to outer support structure 102 only at first corner 2831 and second corner 2833.

In one embodiment, first end portion 2592 and second end portion 2594 of mounting rail 2590 are attached to third corner 2835 and fourth corner 2837, respectively, of outer support structure 102. Additionally, intermediate portion 2596 of mounting rail 2590 is spaced inwardly from second edge 2804 of inner frame 2640. In other words, mounting rail 2590 is attached to outer support structure 102 only at third corner 2835 and fourth corner 2837.

As seen in FIG. 28, this arrangement provides first gap 2810 between first edge 2802 and outer support structure 102. Moreover, intermediate portion 2586 of first mounting rail 2580 may be spaced apart from outer support structure 102 by gap 2895. With this arrangement, a crib skirt or similar provision could be draped from edge 2802 without any interference from linkage assembly 2550. Likewise, this arrangement provides second gap 2812 between second edge 2804 and outer support structure 102 where a crib skirt or similar provision could be placed without any interference from linkage assembly 2550. Also, in some cases, intermediate portion 2596 of second mounting rail 2590 may be spaced apart from outer support structure 102 by gap 2897. With this arrangement, a crib skirt or similar provision could be draped from edge 2804 without any interference from linkage assembly 2550.

In some cases, this arrangement may allow a standard crib skirt that is split at each corner to be used with inner frame 2640 since inner frame 2640 is only mounted to outer structure 102 at the corners of assembly 2500. For example, a standard crib skirt with four distinct portions divided at the corners could be draped down from edge 2802, edge 2804, edge 2806 and edge 2809 without interfering with any portion of the linkage assembly.

Referring back to FIGS. 25 and 26, linkage assembly 2550 can be configured with some similar components to linkage assembly 1350 that is described above in reference to FIGS. 13 and 14. For purposes of illustration, like parts are denoted with like numbers. For example, linkage assembly 2550 may include first linkage member 1352, second linkage member 1354 and third linkage member 1356. As seen with reference to FIG. 28, first linkage member 1352 is associated with first edge 2802 of inner frame 2640 while second linkage member 1354 may be associated with second edge 2804 of inner frame 2640. In addition, third linkage member 1356 may be associated with rear edge 2808 of inner frame 2640.

As seen in FIGS. 25 through 27, in some embodiments, end 1403 of first linkage member 1352 may be secured to rear mounting portion 2706 of mounting rail 2580. In some cases, end 1403 can be secured using bracket 2910. Bracket 2910 can be secured to mounting rail 2580 using any types of fasteners. In some cases, fastening pins may be used to secure bracket 2910 to mounting rail 2580. In some cases, end 1404 of second linkage member 1354 could be secured to a rear mounting portion of mounting rail 2590 in a similar manner. Likewise, end 1404 could be secured to mounting rail 2590 using any type of fasteners including fastening pins. In other cases, first linkage member 1352 and second linkage member 1354 could be secured directly to first mounting rail 2580 and second mounting rail 2590, respectively, without the use of any intermediate brackets. In such cases, any types of fasteners could be used including nut and bolts, screws, rivets, pins as well as any other kinds of fasteners.

In some cases, end 1401 of first linkage member 1352 may be secured to slot portion 2702 by sliding assembly 173. Likewise, in some cases, end 1402 of second linkage member 1352 may be secured to a corresponding slot portion on mounting rail 2590. This allows first linkage member 1352 and second linkage member 1354 to translate along a portion of the lengths of mounting rail 2580 and mounting rail 2590, which further allows inner frame 2640 to be raised and lowered.

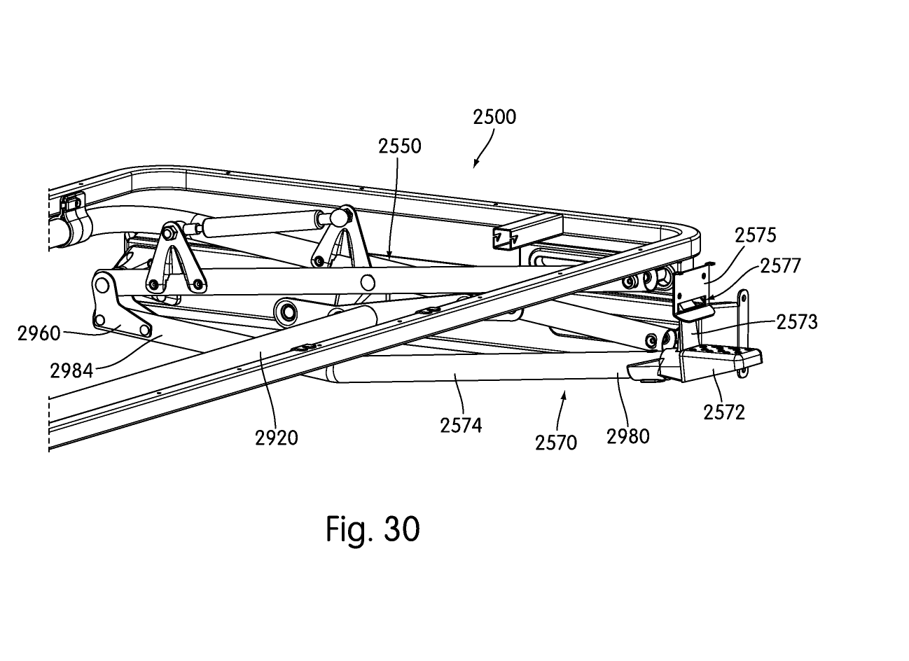

FIGS. 30 through 33 illustrate various views of a portion of adjustable assembly 2500, including portions of linkage assembly 2550 and pedal assembly 2570. For purposes of clarity, only one side of linkage assembly 2550 is shown, corresponding to the side connected with pedal assembly 2570. However, it will be understood that the opposing side of linkage assembly 2550 may be configured and operated in a substantially similar manner to the side shown in FIGS. 30 through 33.

Referring now to FIGS. 30 through 33, assembly 2500 includes pedal assembly 2570 for raising and lowering linkage assembly 2550. Pedal assembly 2570 includes pedal 2572 and pedal linkage member 2574. End 2980 of pedal linkage member 2574 may be attached to pedal 2572. Moreover, in some embodiments, end 2984 of pedal linkage member 2574 is attached to first bracket 2960, which is disposed at a rearmost location of linkage assembly 2550. Using this arrangement, the center point of the arc of the pedal is located as far back as possible along the assembly.

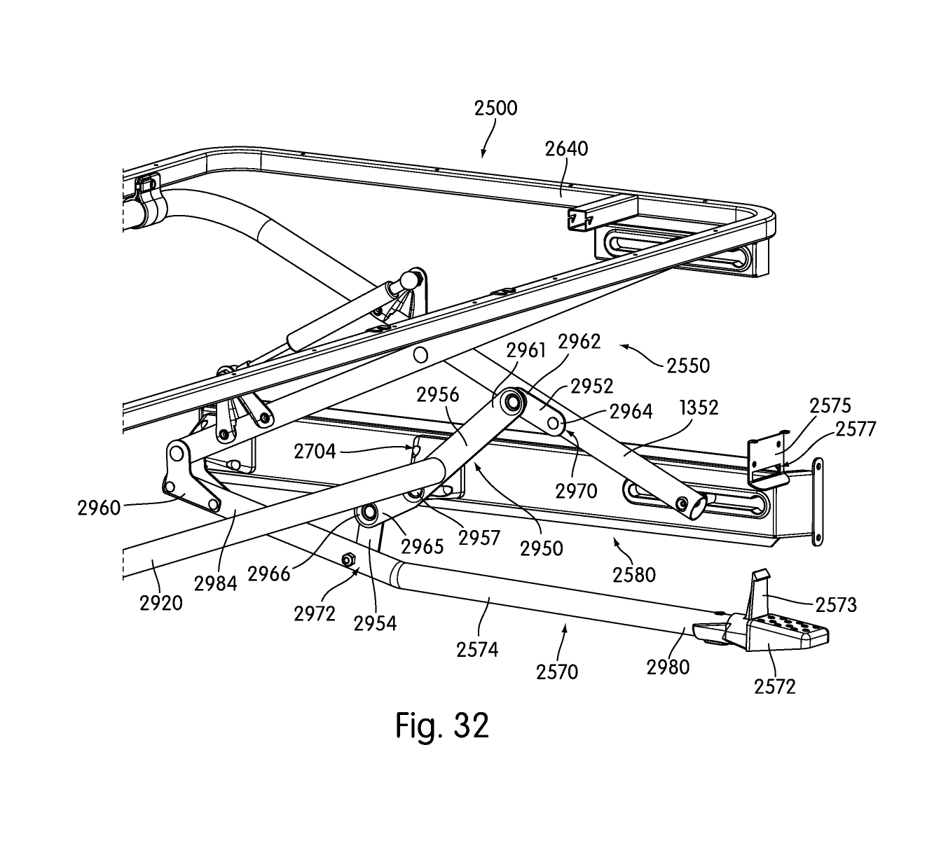

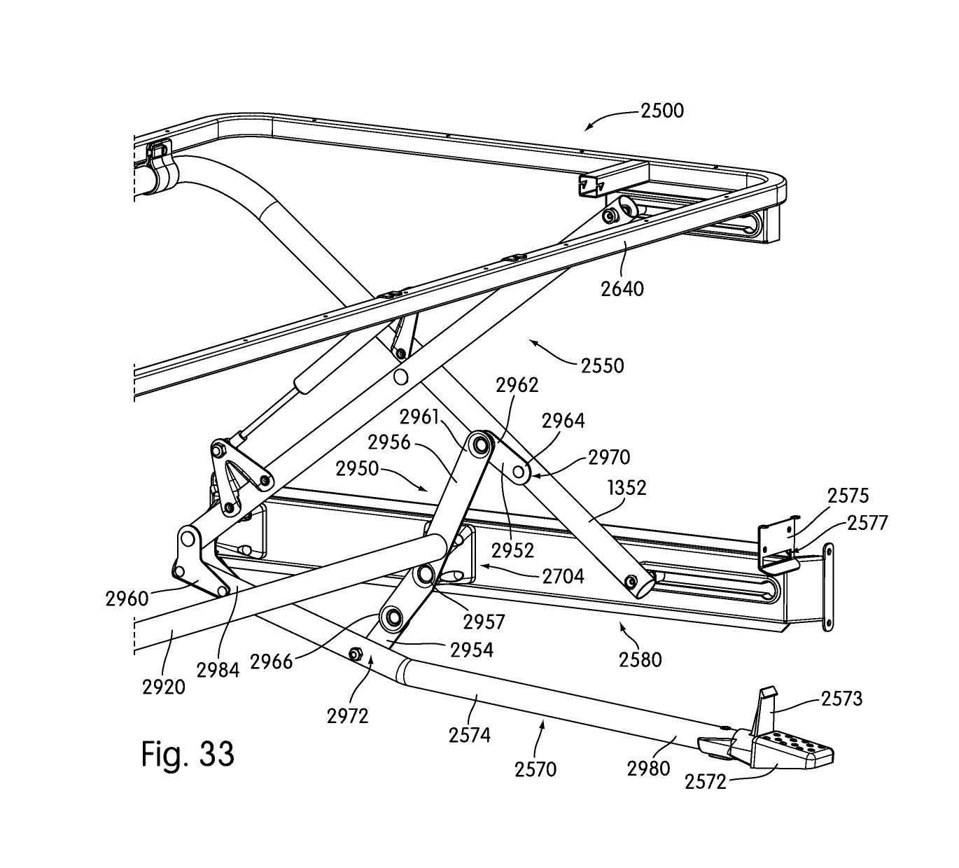

Assembly 2500 can include cross bar member 2920 that extends along the length of outer support structure 102 and which facilitates the operation of pedal assembly 2570. Cross bar member 2920 may be further associated with linkage sub-assembly 2950, which is best illustrated in FIGS. 32 and 33. In some cases, linkage sub-assembly 2950 includes first link portion 2952, second link portion 2954 and intermediate link portion 2956. Intermediate link portion 2956 may be integrally formed with cross bar member 2920 in some cases. In other cases, however, intermediate link portion 2956 could be separately formed from cross bar member 2920 and attached to cross bar member 2920 using any types of fasteners.

In some cases, first end 2961 intermediate link portion 2956 is pivotally connected with first end 2962 of first link portion 2952. Second end 2964 of first link portion 2952 may be further pivotally connected with attachment portion 2970 of first linkage member 1352. In some cases, second end 2965 of intermediate link portion 2956 is pivotally connected with first end 2966 of second link portion 2954. A second end (not shown) of second link portion 2954 may be further pivotally connected with attachment portion 2972 of pedal linkage member 2574. Moreover, fastening portion 2957 of intermediate link portion 2956 may be pivotally mounted to central mounting portion 2704 of mounting rail 2580. Using this configuration for linkage sub-assembly 2950 allows a generally upward force to be applied to first linkage member 1352 as pedal 2572 is lowered, which acts to raise inner frame 2640.

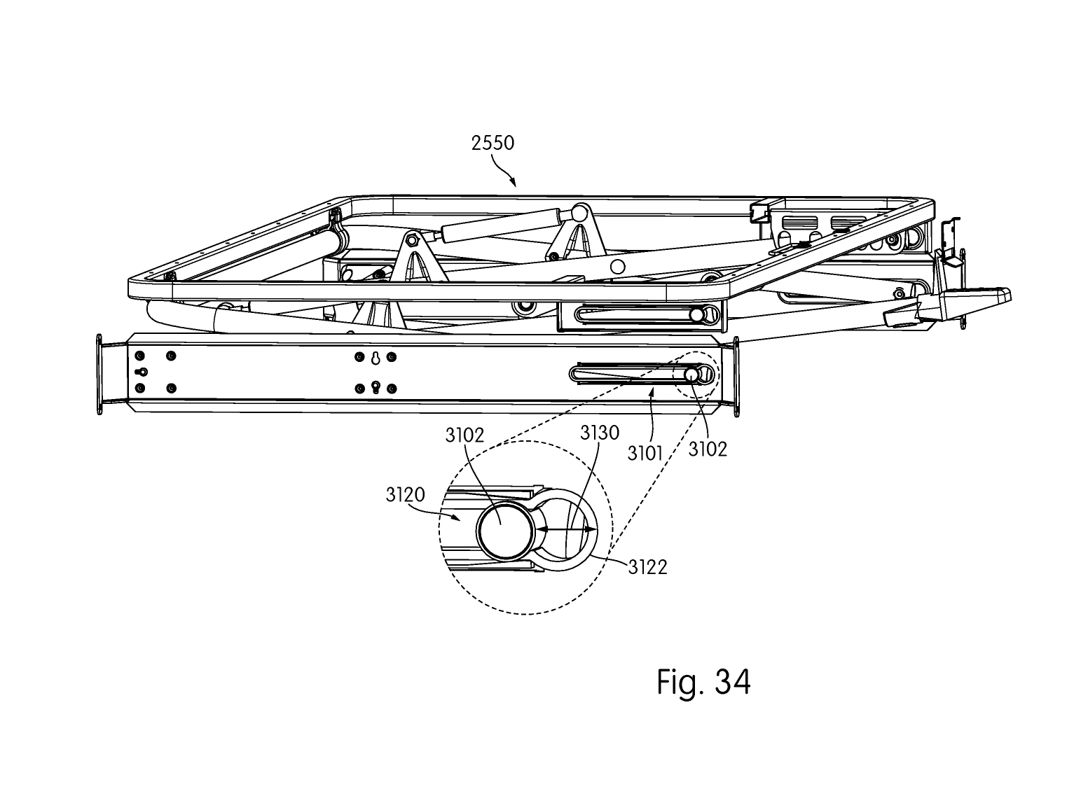

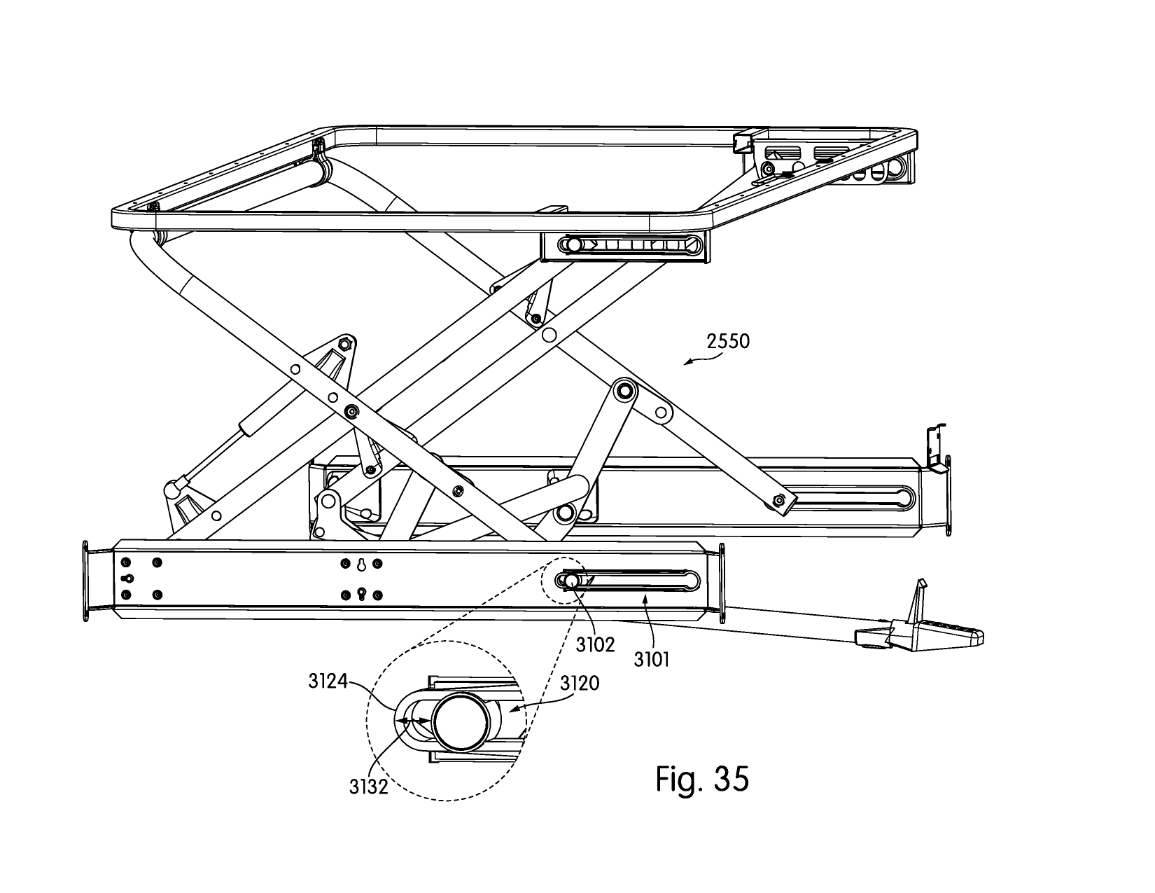

In some cases, the configuration described here for linkage sub-assembly 2950 helps prevent over extension of the linkage assembly 2550 by constraining the amount by which first linkage member 1352 or second linkage member 1354 can be raised. In some cases, this arrangement also helps to reduce pinch points, by providing spacing between the sliding member and the ends of a slot. In other words, this configuration for linkage sub-assembly 2950 provides some gaps or spacing between each sliding member and the end of a slot at all points of travel. For example, referring to FIG. 34, in the lowered position, sliding member 3102 is spaced apart from first end portion 3122 of slot 3120 by spacing 3130. In the fully raised position, shown in FIG. 35, sliding member 3102 is spaced apart from second end portion 3124 of slot 3120 by spacing 3132. Each spacing, or gap, may help reduce the chances that the ends of slot 3120 will become a pinch point. It will be understood that each sliding assembly can be configured in a similar manner to sliding assembly 3101, shown in FIGS. 34 and 35, in order to reduce possible pinch points at each sliding assembly.

In some cases, the spacing between a slot end and a sliding member may be greater than or equal to a minimum spacing. For example, in some cases, the minimum spacing could be between 0.5 centimeter and 10 centimeters. In other cases, the minimum spacing could have any other value. In some cases, the minimum spacing could be associated with the width of a finger.

It will be understood that any types of fasteners may be used for securing various different components together. In some cases, a fastener could comprise a bolt with a nut. In other cases, a fastener could include screws, nails, pins, rivets or any other kinds of fasteners known in the art. In particular, each fastener may be selected according to the specific features of the components being connected. In embodiments where assembly 2500 is configured to be assembled by a customer or user, the fasteners could be selected to provide increased ease of assembly. In some cases, some fasteners may provide a pivoting connection between two or more components. In other cases, some fasteners may fasten two components in a manner that restricts or prevents any relative rotation or movement.

In some embodiments, pedal assembly 2570 may include provisions for locking adjustable assembly 2500. In one embodiment, as seen in FIGS. 30 through 33, pedal 2572 includes latching portion 2573. In some cases, latching portion 2573 may be configured to engage a corresponding latch receiving bracket 2575. In some cases, bracket 2575 could be mounted to a portion of outer support structure 102. Moreover, in some cases, bracket 2575 may include slot 2577 that receives latching portion 2573.

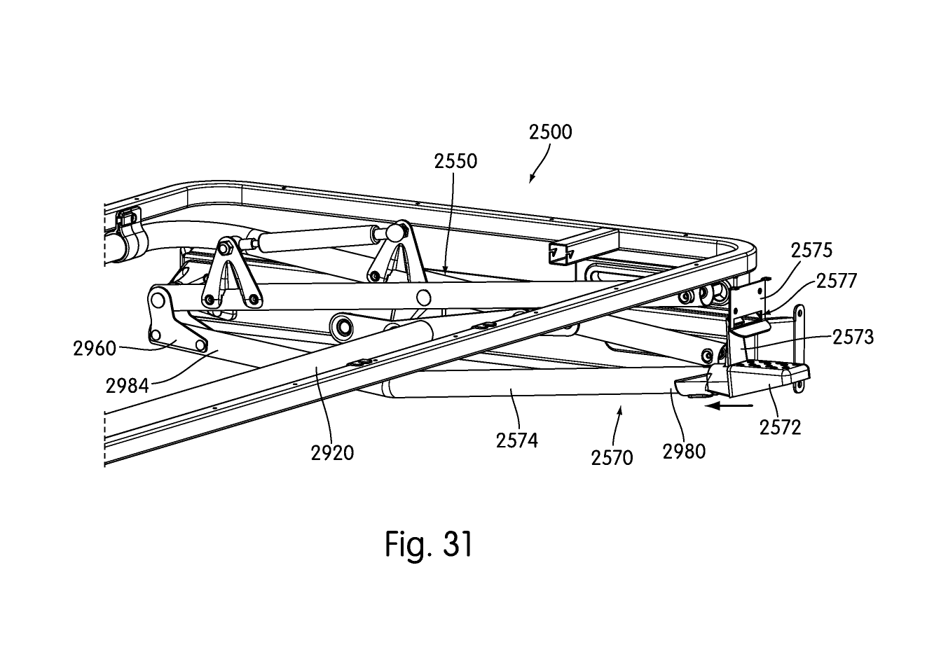

In order to lock and unlock adjustable assembly 2500, pedal 2572 could be mounted to end 2980 of pedal linkage member 2574. In some cases, pedal 2572 could be mounted using a spring (not shown), so that pedal 2572 is naturally biased in a forward position such that latching portion 2573 is latched to slot 2577 (see FIG. 30). To release adjustable assembly 2500 and raise frame member 2640, pedal 2572 could be pushed back along pedal linkage member 2574 until latching portion 2573 disengages slot 2577 (see FIG. 31). Then, pedal 2572 could be depressed in order to actuate adjustable assembly 2500 (see FIGS. 32 and 33).

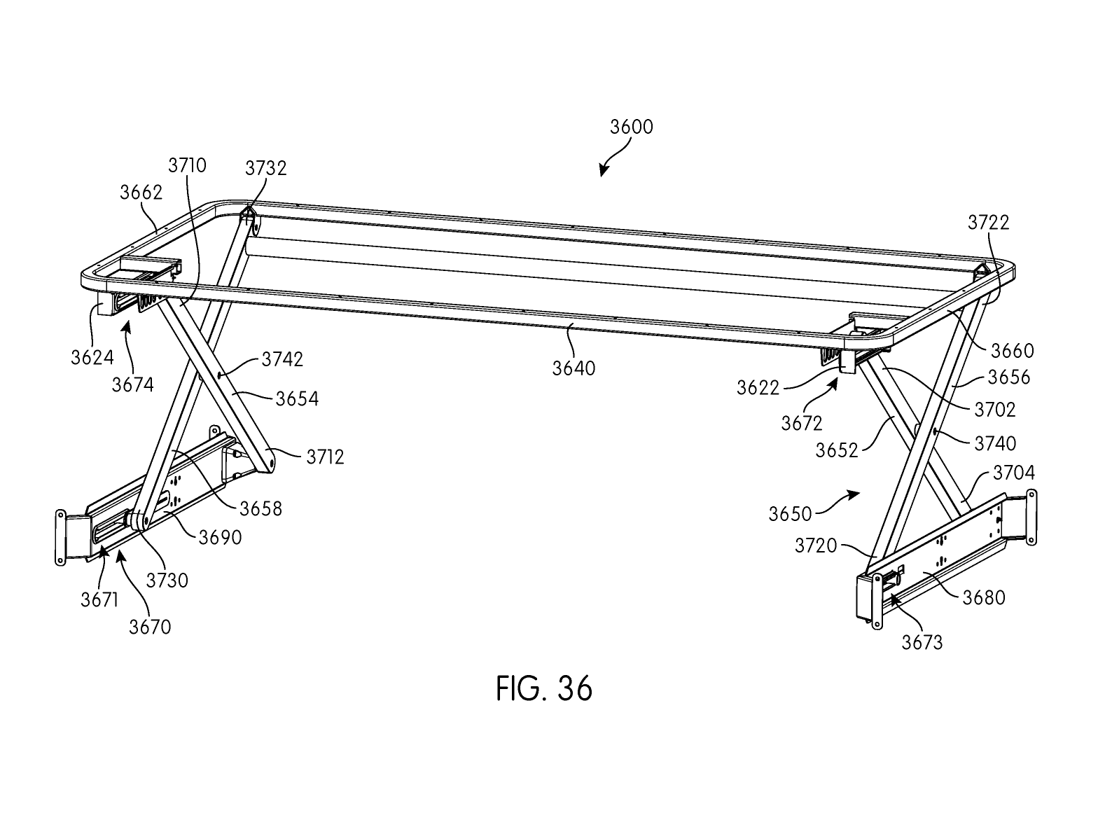

FIG. 36 illustrates a schematic view of an embodiment of height adjustable assembly 3600, or simply assembly 3600. In some cases, height adjustable assembly 3600 may take the form of a crib frame. However, in other cases, height adjustable assembly 3600 may take any other form. For purposes of clarity, height adjustable assembly 3600 is shown without an outer support structure, which could include legs, sidewalls and rails for a crib. An example of such an outer support structure is shown in phantom in FIG. 1.

In some embodiments, assembly 3600 may be associated with frame member 3640. In embodiments where assembly 3600 is associated with a crib, frame member 3640 may comprise a frame for supporting a mattress or any other kind of bedding surface. In some cases, frame member 3640 comprises a simple rectangular frame. In other cases, however, frame member 3640 may have any other shape.

Assembly 3600 can include provisions that allow frame member 3640 to be raised and lowered. In some cases, assembly 3600 may include a linkage assembly that may be used to adjust the height of frame member 3640. In some cases, a linkage assembly may be used to raise and lower frame member 3640 within an outer support structure (not shown). This allows the relative distance between the bedding surface and the top of the railings of a support structure to be changed.

In one embodiment, assembly 3600 comprises linkage assembly 3650. Linkage assembly 3650 may provide a connection between frame member 3640 and an outer support structure as described in previous embodiments. For example, as discussed in previous embodiments, the lower ends of linkage assembly 3650 may be mounted to the legs of an outer support structure using mounting rails.

In some embodiments, linkage assembly 3650 may include first linkage member 3652, second linkage member 3654, third linkage member 3656 and fourth linkage member 3658. First linkage member 3652 and third linkage member 3656 may be associated with first side 3660 of frame member 3640. In addition, second linkage member 3654 and fourth linkage member 3658 may be associated with second side 3662 of frame member 3640.

In different embodiments, the geometries of one or more linkage members could vary. In some cases, a linkage member could have a tube-like geometry. In other cases, a linkage member could have a flattened geometry. Moreover, in some cases one or more linkage members could be substantially straight. In other cases, one or more linkage members could be curved. In one embodiment, first linkage member 3652, second linkage member 3654, third linkage member 3656 and fourth linkage member 3658 comprise substantially straight tube-like members. Moreover, in some cases, the cross sectional shapes of each linkage member could have any shape including, but not limited to: rounded shapes, rectangular shapes, polygonal shapes, regular shapes and irregular shapes. In one embodiment, each linkage member may have an approximately rectangular cross-sectional shape. It will be understood that other embodiments are not restricted to linkage members with a particular kind of geometry.

Assembly 3600 can include sliding assemblies 3670 that allow the ends of linkage members to slide with respect to various components of assembly 3600. In some cases, sliding assemblies 3670 may include first sliding assembly 3671, second sliding assembly 3672, third sliding assembly 3673 and fourth sliding assembly 3674. In some cases, sliding assemblies 3670 may be substantially similar to sliding assemblies 170 discussed above and shown in FIGS. 1-4. For example, each of sliding assemblies 3670 may comprise a receiving member and corresponding sliding member.

In some cases, second sliding assembly 3672 and fourth sliding assembly 3674 may provide sliding connections between frame member 3640 and linkage assembly 3600. In some cases, second sliding assembly 3672 and fourth sliding assembly 3674 may be engaged with first bracket 3622 and second bracket 3624, respectively. First bracket 3622 and second bracket 3624 may be mounted directly to first side 3660 and second side 3662, respectively, of frame member 3640.

As discussed previously, an adjustable assembly can include provisions for preventing a linkage assembly from interfering with any components that hang down from the edges of a mattress frame. In some cases, this could be accomplished using a mounting rail that mounts to the legs of an outer support structure and provides a sliding connection for the adjustable assembly.

In some embodiments, adjustable assembly 3600 may include first mounting rail 3680 and second mounting rail 3690. In some cases, first mounting rail 3680 and second mounting rail 3690 could be substantially similar to first mounting rail 2580 and second mounting rail 2590 of a previous embodiment (shown in FIG. 25). Each mounting rail can include provisions for receiving components of sliding assemblies 3670 and linkage assembly 3650. In some cases, first mounting rail 3680 may include provisions for receiving third sliding assembly 3673 as well as for pivotally attaching to first linkage member 3652. Also, in some cases, second mounting rail 3690 may include provisions for receiving first sliding assembly 3671 as well as for pivotally attaching to second linkage member 3654.

As seen in FIG. 36, first end portion 3702 of first linkage member 3652 may slide with respect to frame member 3640 via second sliding assembly 3672. Likewise, second end portion 3704 of first linkage member 3652 may pivot with respect to first mounting rail 3680. Additionally, first end portion 3710 of second linkage member 3654 may slide with respect to frame member 3640 via fourth sliding assembly 3674. Likewise, second end portion 3712 of second linkage member 3654 may pivot with respect to second mounting rail 3690. In some cases, first end portion 3720 of third linkage member 3656 may slide with respect to first mounting rail 3680 via sliding assembly 3673. Likewise, second end portion 3722 of third linkage member 3656 may pivot with respect to frame member 3640. Finally, in some cases, first end portion 3730 of fourth linkage member 3658 may slide with respect to sliding assembly 3671. Likewise, second end portion 3732 of fourth linkage member 3658 may pivot with respect to frame member 3640.

In some cases, first linkage member 3652 and third linkage member 3656 may be arranged in an x-like configuration that pivots about pivoting connection 3740. Also, second linkage member 3654 and fourth linkage member 3658 may be arranged in an x-like configuration that pivots about pivoting connection 3742. This configuration allows for frame member 3640 to be raised and lowered as the respective first end portions of first linkage member 3652, second linkage member 3654, third linkage member 3656 and fourth linkage member 3658 are moved along sliding assembly 3672, sliding assembly 3674, sliding assembly 3673 and sliding assembly 3671, respectively.

It will be understood that any types of fasteners may be used for securing various different components together. In some cases, a fastener could comprise a bolt with a nut. In other cases, a fastener could include screws, nails, pins, rivets or any other kinds of fasteners known in the art. In particular, each fastener may be selected according to the specific features of the components being connected. In embodiments where assembly 3600 is configured to be assembled by a customer or user, the fasteners could be selected to provide increased ease of assembly. For example, in some embodiments, most or all connections could be factory riveted in order to facilitate ease of assembly by the user. In some cases, some fasteners may provide a pivoting connection between two or more components. In other cases, some fasteners may fasten two components in a manner that restricts or prevents any relative rotation or movement.

A height adjustable assembly can include provisions for allowing a user to manually adjust the height of a frame member. In some cases, a height adjustable assembly can include provisions for fixing the position of a sliding member with respect to a receiving member. In one embodiment, a height adjustable assembly can include at least one locking assembly that serves to fix or lock the position of at least one sliding member with respect to an associated receiving member.

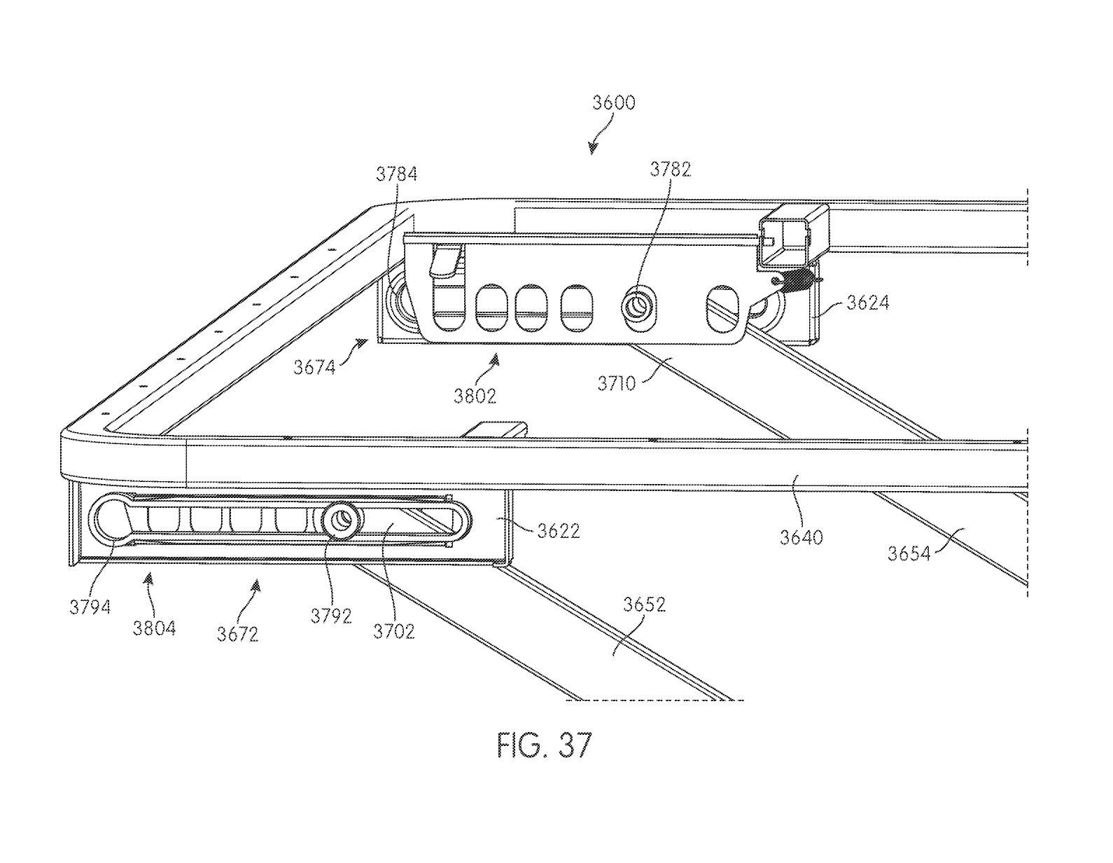

FIG. 37 illustrates an enlarged isometric view of a portion of assembly 3600. Referring to FIG. 37, assembly 3600 may include first locking assembly 3802 and second locking assembly 3804. In some cases, first locking assembly 3802 may be associated with fourth sliding assembly 3674. In particular, first locking assembly 3802 may be used to lock the position of first sliding member 3782 with respect to first receiving member 3784 of fourth sliding assembly 3674. Additionally, in some cases, second locking assembly 3804 may be associated with second sliding assembly 3672. In particular, second locking assembly 3804 may be used to lock the position of second sliding member 3792 with respect to second receiving member 3794. Each different locking position for first sliding member 3782 and second sliding member 3792 may correspond to a different fixed position for linkage assembly 3650. Moreover, each fixed position for linkage assembly 3650 (see FIG. 36) may correspond to a different height for frame member 3640.

In the current embodiment, first locking assembly 3802 and second locking assembly 3804 are disposed on opposing sides of frame member 3640. However, other embodiments could include locking assemblies disposed on any other portion of assembly 3600 including portions associated with any of sliding assemblies 3670. For example, in another embodiment, at least one locking assembly could be associated with first mounting rail 3680 and/or second mounting rail 3690 (see FIG. 36).

While the current embodiment includes two locking assemblies, other embodiments could include any other number of locking assemblies. In some cases, a height adjustable assembly may comprise a single locking assembly. In other cases, three locking assemblies could be used. In still other cases, four or more locking assemblies could be used.

In some embodiments, the arrangement of first locking assembly 3802 and second locking assembly 3804 may be substantially similar. In other words, the configuration and operation of second locking assembly 3804 with respect to second sliding assembly 3672 and first linkage member 3652 may be substantially similar to the configuration and operation of first locking assembly 3802 with respect to fourth sliding assembly 3674 and second linkage member 3654. In other cases, however, each locking assembly could have a substantially different configuration.

For purposes of clarity, the following detailed discussion focuses on the operation of first locking assembly 3802. However, it should be understood that in some cases the same principles may generally apply to the operation of second locking assembly 3804.

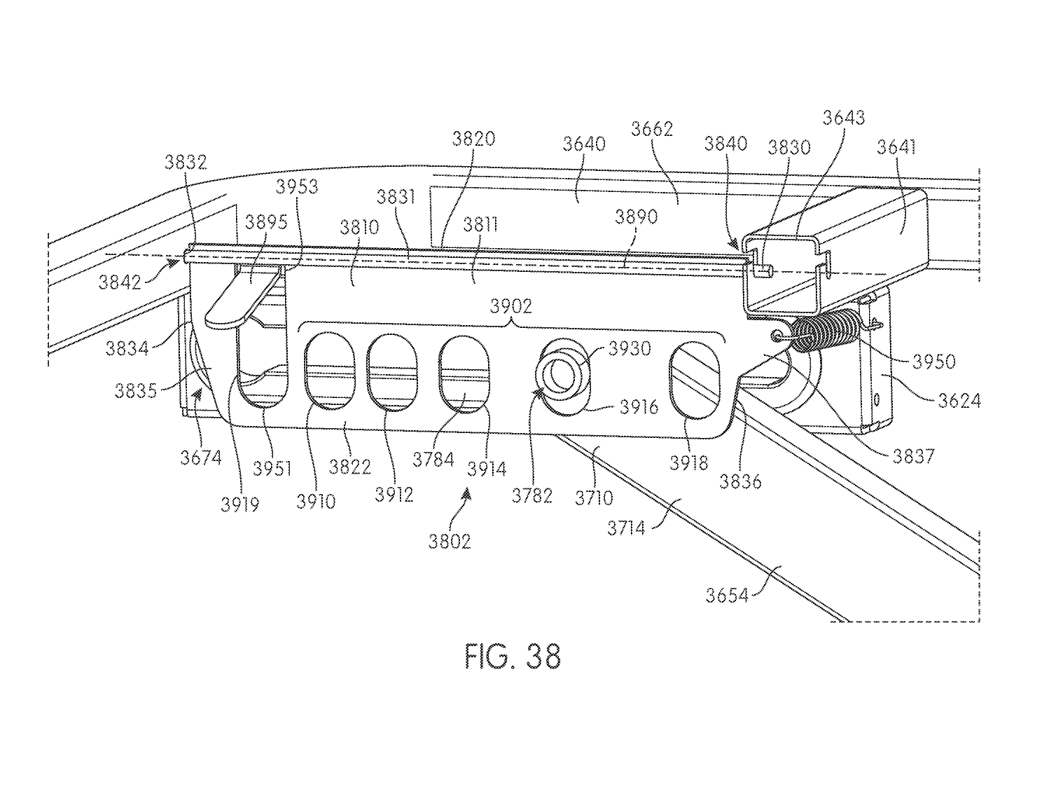

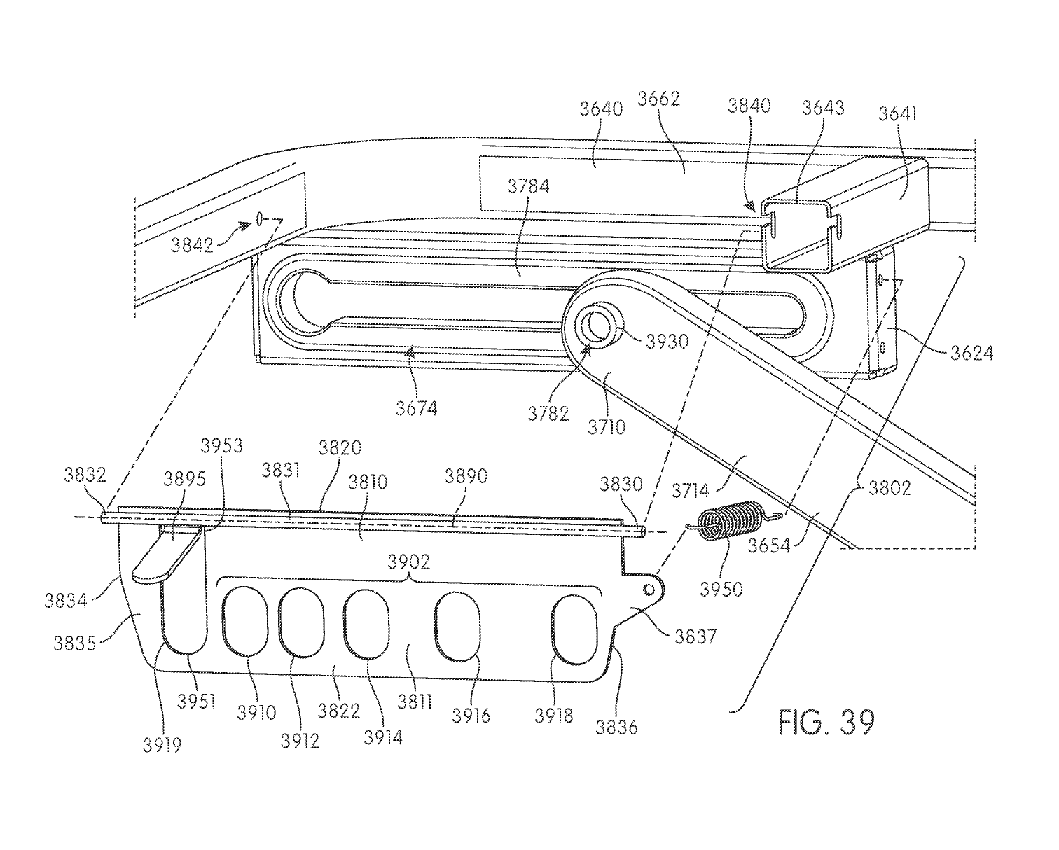

FIGS. 38 and 39 illustrate an isometric assembled and isometric exploded view, respectively, of first locking assembly 3802. First locking assembly 3802 may generally be configured to lock second linkage member 3654 at a fixed location with respect to frame member 3640. In particular, first locking assembly 3802 may lock first end portion 3710 of second linkage member 3654 at a fixed position along receiving member 3784.

First locking assembly 3802 may comprise a plurality of components, including locking plate 3810. In some cases, locking plate 3810 may generally be disposed adjacent to sliding assembly 3674. In some cases, locking plate 3810 may be disposed adjacent to linkage member 3654. In one embodiment, locking plate 3810 is generally disposed adjacent to a proximal surface 3714 of linkage member 3654. In some embodiments, locking plate 3810 may be disposed inwardly of frame member 3640, sliding assembly 3674 and linkage member 3654. In other cases, however, locking plate 3810 could be disposed between linkage member 3654 and frame member 3640. In still other cases, locking plate 3810 may be disposed distally or outwardly of frame member 3640 and/or sliding assembly 3674.

In different embodiments, the geometry of locking plate 3810 could vary. In some cases, locking plate 3810 may comprise a substantially flat component. In particular, in some cases, the length and width of locking plate 3810 may be substantially greater than the thickness or depth of locking plate 3810. In some cases, the geometry of locking plate 3810 may be further characterized by upper edge 3820 and lower edge 3822. In some cases, upper edge 3820 and lower edge 3822 may be approximately straight edges. In other cases, however, upper edge 3820 and/or lower edge 3822 may be curved edges.

In some embodiments, the length of locking plate 3810 is such that locking plate 3810 extends along a majority of the length of receiving member 3784. This allows locking plate 3810 to be used to fix the position of sliding member 3782 at various locations along the full length of receiving member 3784, as discussed in further detail below. In other cases, however, the length of locking plate 3810 may be such that locking plate 3810 only extends along a small portion of receiving member 3784. Still further, in some cases, the length of locking plate 3810 could be substantially greater than the length of receiving member 3784.

In some embodiments, locking plate 3810 may further be characterized by first side edge 3834 and second side edge 3836. In some cases, first side edge 3834 and second side edge 3836 may be curved or otherwise irregular edges. For example, in some cases, first side edge 3834 comprises an angled portion 3835. Likewise, in some cases, second side edge 3836 includes flange portion 3837.

For purposes of describing the geometry and orientation of locking plate 3810, reference may be made to a longitudinal direction and a lateral direction of locking plate 3810. The longitudinal direction may be a direction generally oriented along the length of locking plate 3810. The lateral direction may be a direction generally oriented along the width of locking plate 3810.

In some embodiments, locking plate 3810 may be attached to frame member 3640. In some cases, locking plate 3810 may be fastened to frame member 3640 using one or more fasteners. In one embodiment, locking plate 3810 and frame member 3640 may be connected in a manner that allows locking plate 3810 to rotate with respect to frame member 3640. In some cases, locking plate 3810 can be configured to swing or pivot with respect to frame member 3640.

In one embodiment, for example, locking plate 3810 comprises first connecting portion 3830 and second connecting portion 3832 that engage first receiving hole 3840 and second receiving hole 3842, respectively. First connecting portion 3830 and second connecting portion 3832 may generally comprise rod-like projections. In some cases, first connecting portion 3830 and second connecting portion 3832 may be end portions of a rod-like member 3831 that is mounted along upper edge 3820. In some cases, first connecting portion 3830 and second connecting portion 3832 are configured to rotated within first receiving hole 3840 and second receiving hole 3842, respectively. This provides an arrangement where locking plate 3810 can rotate with respect to frame member 3640. In the current embodiment, for example, locking plate 3810 may be configured to rotate about rotational axis 3890. In some cases, rotational axis 3890 may be aligned with first connecting portion 3880 and second connecting portion 3882. Moreover, in some cases, rotational axis 3890 may be aligned approximately with upper edge 3820 of locking plate 3810. In such cases,

In order to support locking member 3810, frame member 3640 may include mounting portion 3641 that extends outwardly from second side 3662 of frame member 3640. In some cases, mounting portion 3641 has a box-like geometry and provides a mounting location opposing second receiving hole 3642, which may be disposed directly within frame member 3640. In order to facilitate the attachment of locking plate 3810 to assembly 3600, first receiving hole 3640 may comprise an slot-like hole that is open on proximal edge 3643 of mounting portion 3641. This allows for locking plate 3810 to be installed by first inserting second connecting portion 3832 into second receiving hole 3842 and then inserting first connecting portion 3830 into the open portion of first receiving hole 3840.

In some embodiments, locking plate 3810 may include one or more openings for engaging with a portion of second linkage member 3654 and/or sliding assembly 3674. In some cases, for example, locking plate 3810 could include openings or holes through which a portion of second linkage member 3654 and/or sliding assembly 3674 may be inserted. In one embodiment, locking plate 3810 may comprise plurality of openings 3902.

In different embodiments, the number of openings in plurality of openings 3902 could vary. In some cases, plurality of openings 3902 may comprise one or more openings. In other cases, plurality of openings 3902 could comprise two or more openings. In one embodiment, plurality of openings 3902 could comprise six openings, including first opening 3910, second opening 3912, third opening 3914, fourth opening 3916, fifth opening 3918 and sixth opening 3919.

In different embodiments, the geometry of each opening could vary. In some cases, one or more openings can have shapes including, but not limited to: rounded shapes, circular shapes, elliptic shapes, rectangular shapes, polygonal shapes, regular shapes, irregular shapes as well as any other kinds of shapes. In one embodiment, first opening 3910, second opening 3912, third opening 3914, fourth opening 3916 and fifth opening 3918 may have approximately oval-like shapes. In addition, sixth opening 3919 may have a tab-like shape, including a lower rounded edge 3951 and an approximately straight upper edge 3953.

Each opening can be configured to engage with one or more protrusions associated with a linkage member. The term “protrusion” as used throughout this detailed description and in the claims refers to any component that protrudes outwardly from the linkage member. The term protrusion is not intended to be limited to portions that are part of, or integrally formed with, a linkage member. In some cases, a protrusion may comprise part of a fastener that is engaged with a linkage member. For example, in some cases, a protrusion could be a portion of a sliding member that is fastened to a linkage member. However, in other embodiments, a protrusion may integral with a linkage member.

In the current embodiment, sliding member 3782 may include proximal portion 3930. Proximal portion 3930 may be a protruding portion that protrudes away from proximal side 3714 of linkage member 3654. In some cases, proximal portion 3930 may be comprised of fasteners that help to secure sliding member 3782 against a distal side (disposed opposite of proximal side 3714) of linkage member 3654. With this arrangement, the position of proximal portion 3930 varies as sliding member 3782 slides along receiving member 3784.

Generally, proximal portion 3930 of sliding member 3782 may be sized to fit within one or more openings of plurality of openings 3902. For example, as seen in FIG. 38, proximal portion 3930 may be inserted through fourth opening 3916. Although the current embodiment illustrates proximal portion 3930 as having an approximately circular cross sectional shape, other embodiments could have any other cross sectional shape that is capable of inserting through plurality of openings 3902.

In some embodiments, locking assembly 3802 may include provisions for manually adjusting the position of locking plate 3810. In some cases, locking plate 3810 may be configured with tab portion 3895. In some cases, tab portion 3895 extends outwardly from locking plate 3810. More specifically, tab portion 3895 may form a non-zero angle with proximal surface 3811 of locking plate 3810. In some cases, tab portion 3895 may form an acute angle with proximal surface 3811. In other cases, tab portion 3895 may form an approximately perpendicular angle with proximal surface 3811.

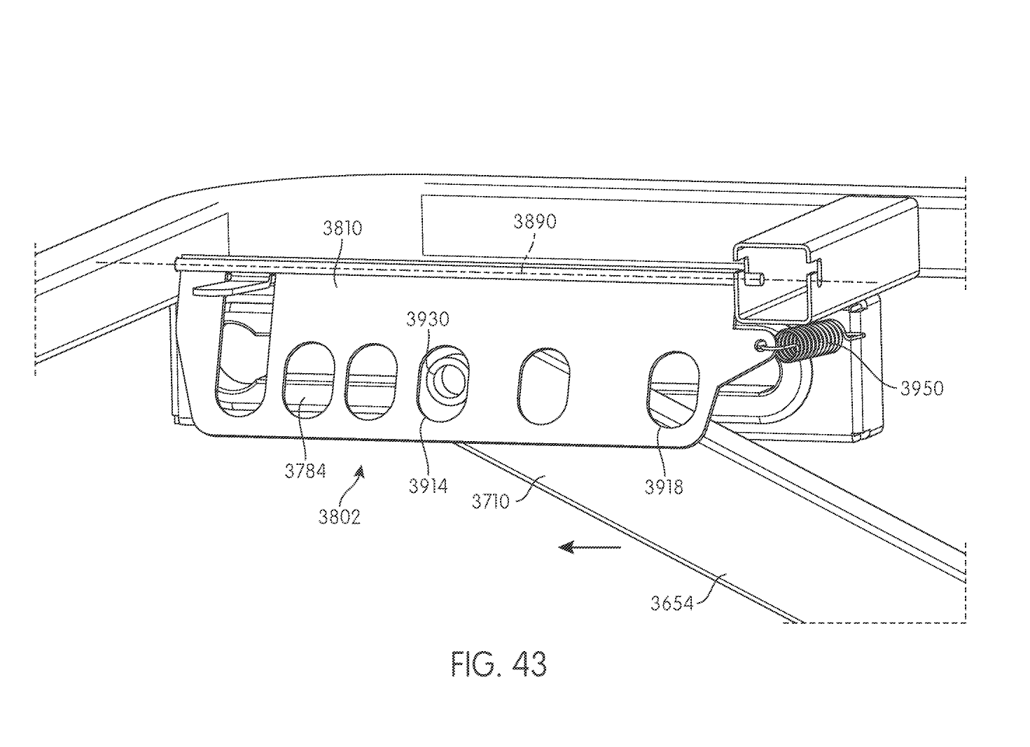

The configuration described here provides for locking plate 3810 to move between an engaged position and a disengaged position. In the engaged position, a protruding portion, such as proximal portion 3930, is inserted through one of plurality of openings 3902 (shown in FIG. 38). This arrangement prevents sliding member 3782 from translating along receiving portion 3674, thereby locking proximal portion 3930 and linkage member 3654 into place. In the disengaged position (see for example, FIG. 43), a protruding portion, such as proximal portion 3930, is not engaged within any of plurality of openings 3902. This arrangement allows sliding member 3782 to translate along receiving portion 3784 thereby allowing linkage assembly 3650 to be adjusted. In particular, in the disengaged position, proximal portion 3930 may move without any interference from locking plate 3810.

Some embodiments can include provisions to bias locking plate 3810 in an engaged position. In some cases, a spring may be used to bias locking plate 3810 in an engaged position. In other cases, any other mechanisms could be used to bias locking plate 3810 into the engaged position. Examples of other mechanisms include, but are not limited to: elastic materials, pneumatic devices as well as any other mechanisms known in the art.

In some embodiments, locking assembly 3802 further includes spring 3950. In some cases, spring 3950 may be attached at one end to bracket 3624 and at an opposing end to locking plate 3810. In some cases, one end of spring 3950 may be attached to flange portion 3837 of locking plate 3810. However, in other cases, spring 3950 could be associated with any other portion of locking plate 3810 and/or frame member 3640.

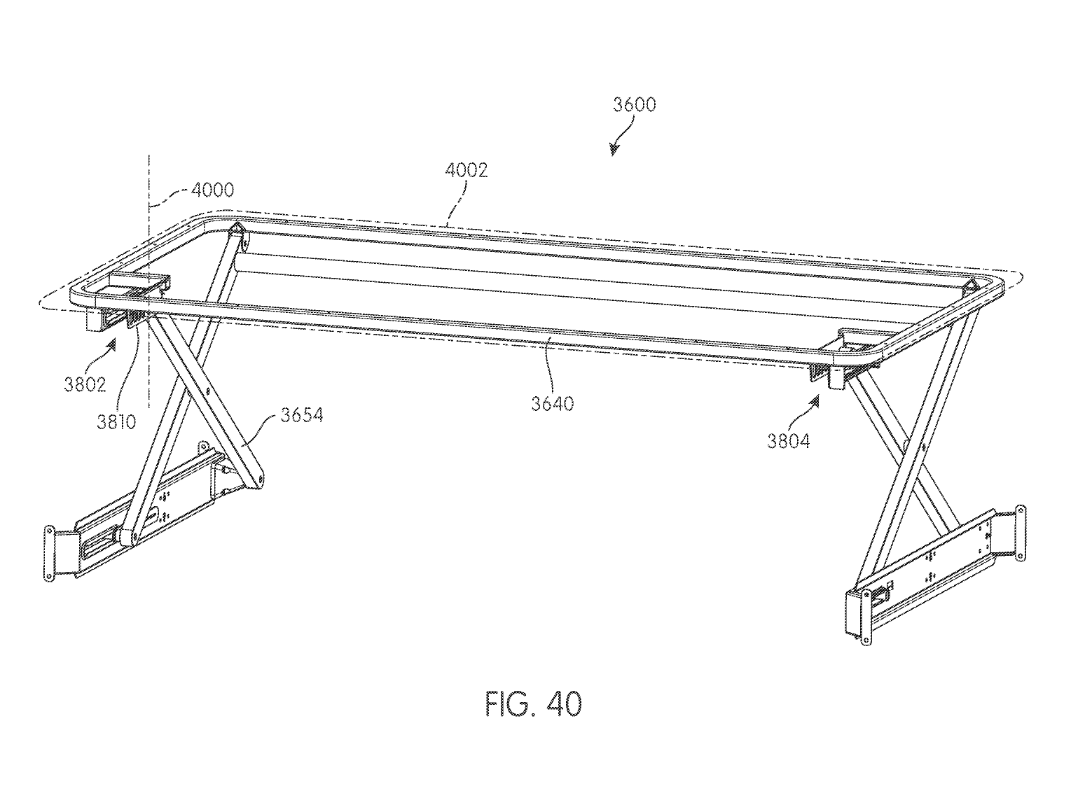

FIGS. 40 through 45 illustrate schematic views of embodiments of a sequence of steps in adjusting the height of assembly 3600. Although these views only show the configurations of first locking assembly 3802 in detail, it will be understood that second locking assembly 3804 may be configured to operate in a similar manner as assembly 3600 is adjusted to different heights.

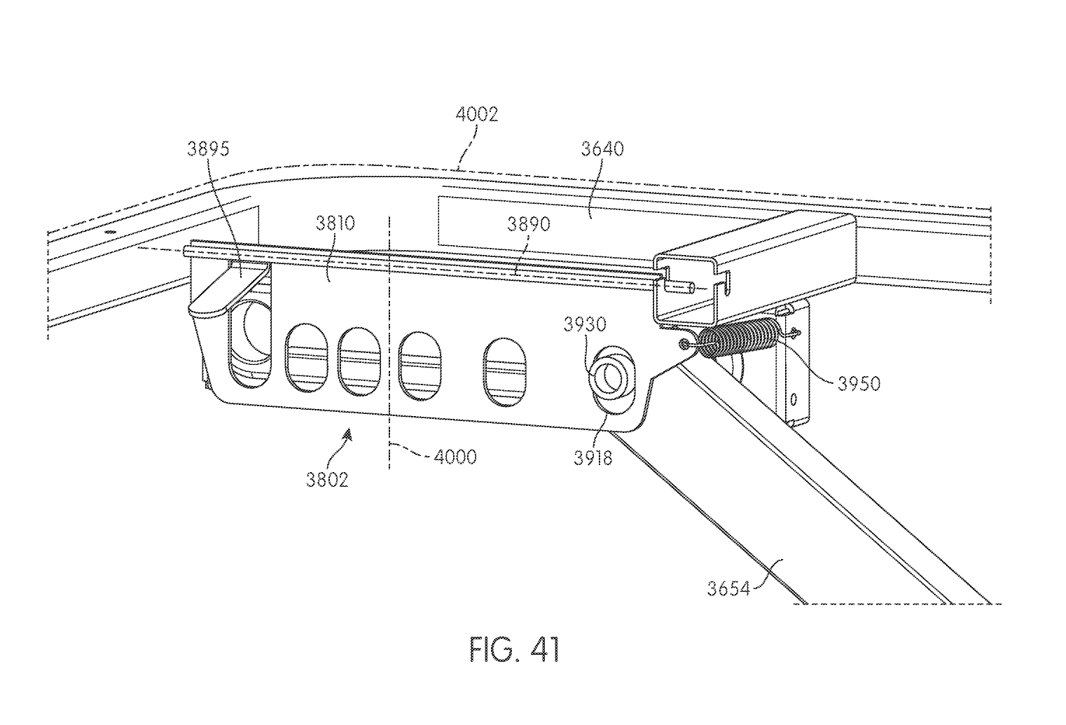

Referring first to FIGS. 40 and 41, for purposes of describing the operation of locking assembly 3802, reference is made to a lateral axis of locking plate 3810. In one embodiment, locking plate 3810 includes lateral axis 4000 that extends through the lateral direction or width of locking plate 3810. Lateral axis 4000 may generally be perpendicular to rotational axis 3890 of locking plate 3810. As shown in FIGS. 41 through 44, the orientation of rotational axis 3890 with respect to frame member 3640 remains substantially constant as locking plate 3810 is moved between the engaged and disengaged positions. In contrast, the orientation of lateral axis 4000 varies with respect to frame member 3640 as locking plate 3810 is moved between the engaged and disengaged positions.

Throughout the description below, reference is also made to a plane that may generally be associated with frame member 3640. As seen in FIGS. 40 and 41, frame member 3640 may be seen to define an approximately planar surface 4002 whose length and width are generally parallel with the length and width of frame member 3640.

In FIGS. 40 and 41, locking plate 3810 is in an engaged position. In this case, proximal portion 3930 is inserted through opening 3918. This configuration corresponds to a fully raised position of assembly 3600. Locking plate 3810 may tend to stay in the engaged position, due to the biasing force of spring 3950.

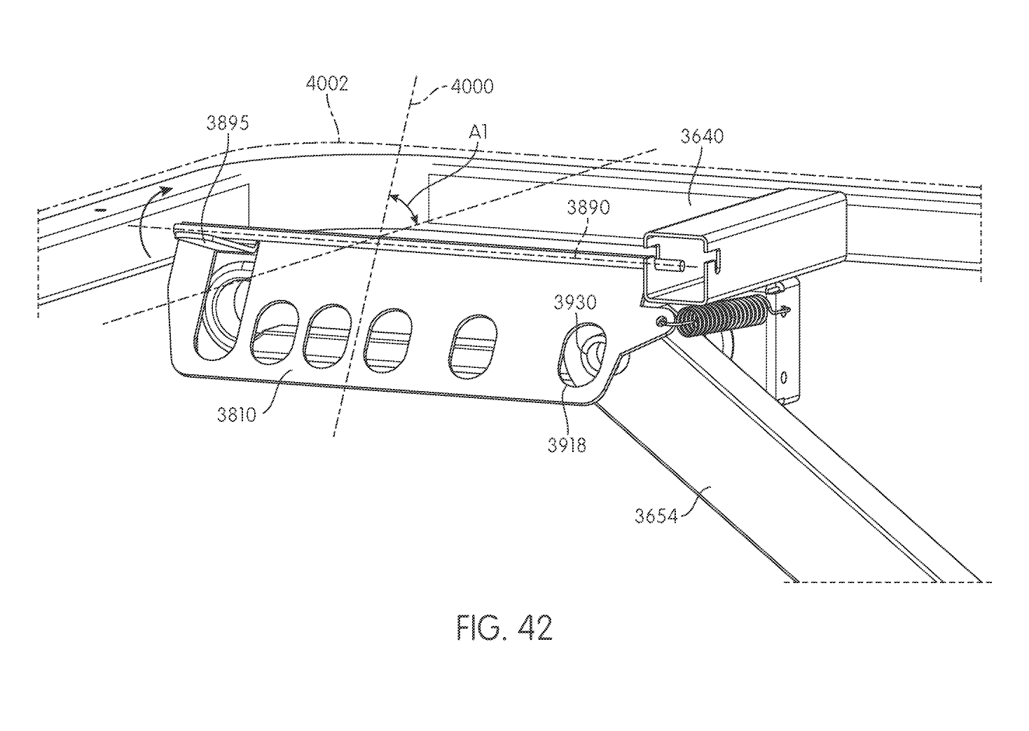

In order to adjust the height of assembly 3600, locking plate 3810 may be rotated away from proximal portion 3930, as seen in FIG. 42. This may be achieved by a user grasping tab portion 3895 and pushing upwardly on tab portion 3895. This causes locking plate 3810 to rotate about rotating axis 3890 so that proximal portion 3930 disengages from opening 3918. As seen in FIG. 41, in the initial engaged position, lateral axis 4000 is approximately perpendicular to planar surface 4002. As locking plate 3810 is moved to the disengaged position shown in FIG. 42, however, lateral axis 4000 forms an acute angle A1 with planar surface 4002.

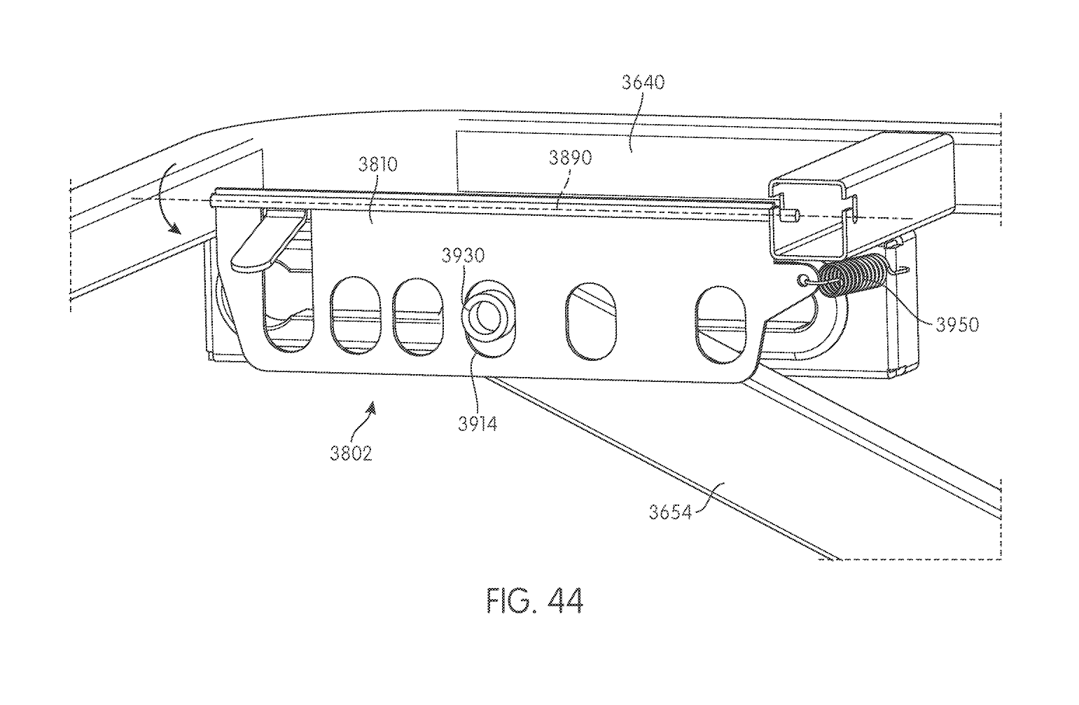

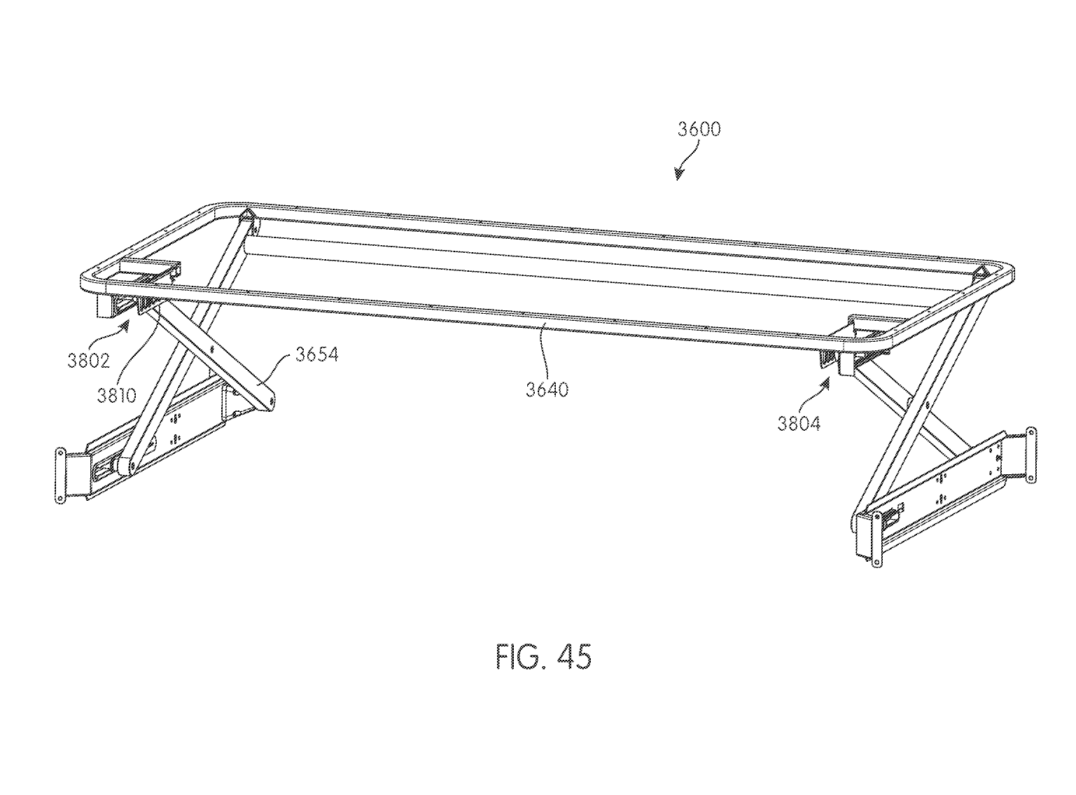

Referring now to FIG. 43, without interference from locking plate 3810, first end portion 3710 of linkage member 3654 may slide to a new position along receiving member 3784. In this new position, proximal portion 3930 may be approximately aligned with third opening 3914. This new position may correspond to a new, and generally lower, height for assembly 3600. As seen in FIG. 44, locking plate 3810 may be rotated back towards proximal portion 3930 to lock the position of linkage member 3654 with respect to frame member 3640. In particular, proximal portion 3930 may be inserted through third opening 3914. With locking plate 3810 biased in this position by spring 3950, locking plate 3810 may lock the height of assembly 3600 at this new height, shown in FIG. 45.

Generally, second locking assembly 3804 may be adjusted simultaneously with first locking assembly 3902 in order to adjust the height of assembly 3600. In order to make this adjustment, a user may gain access to first locking assembly 3802 and second locking assembly 3804 (possibly be raising the mattress of the crib) and lift the corresponding locking plates simultaneously. With both locking plates in the disengaged positions, the user may raise or lower the assembly to the desired height, at which time the locking plates may be reengaged.

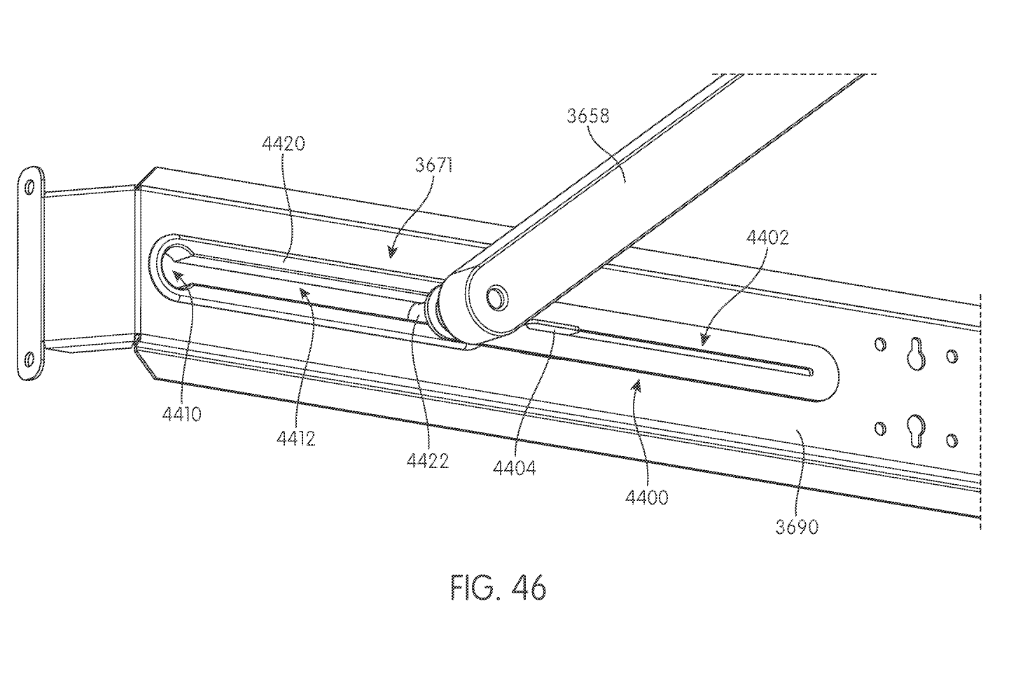

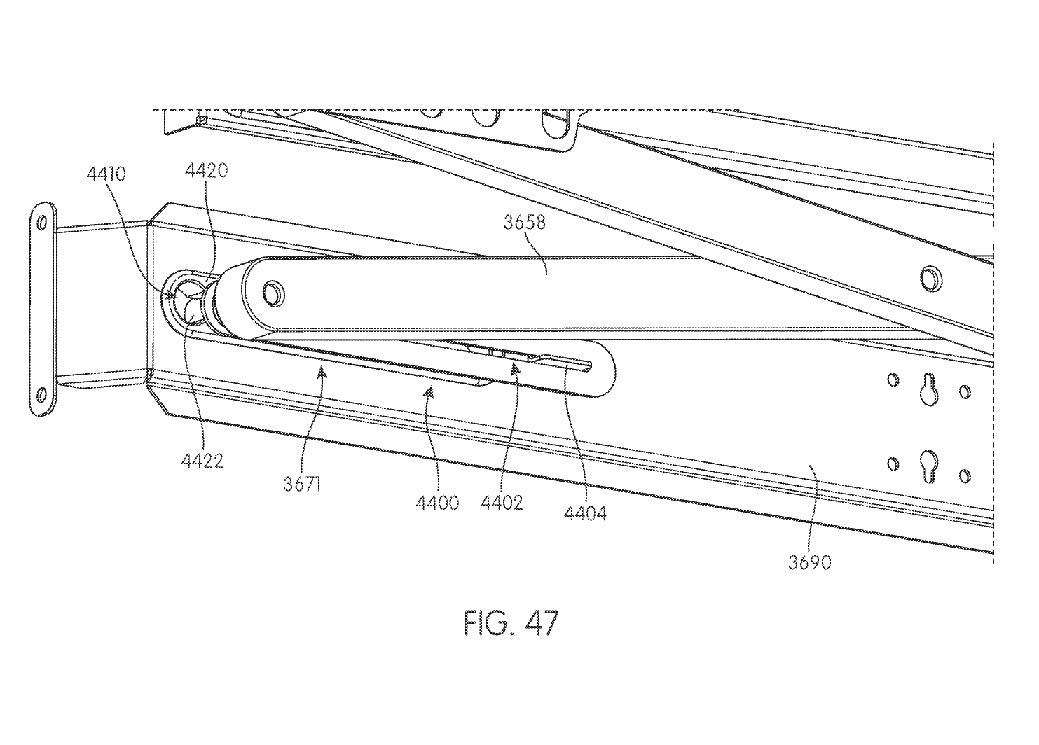

Some embodiments can include provisions to prevent the overextension of a sliding assembly. FIGS. 46 and 47 illustrate schematic close up views of second mounting rail 3690 and sliding assembly 3671. In some cases, assembly 3600 may be configured with sliding assembly guard 4400 that is attached between linkage member 3658 and receiving member 4420. In some cases, guard 4400 is configured to translate along receiving member 4420 with sliding member 4420.

Guard 4400 may further include slot 4402 that is configured to engage tab 4404 of mounting rail 3690. As guard 4400 moves with sliding member 3782, tab 4404 translates within slot 4402. Moreover, the length of slot 4402 may be selected to control the maximum forward extension of sliding member 4422. For example, as seen in FIG. 47, guard 4400 can be configured to prevent sliding member 4422 from translating into wide portion 4410 of receiving member slot 4412. This helps prevent the likelihood that sliding member 4422 could be disengaged from receiving member 4420. In some cases, a similar sliding assembly guard could be configured for use with sliding assembly 3673 (see FIG. 36).

While various embodiments have been described, the description is intended to be exemplary, rather than limiting and it will be apparent to those of ordinary skill in the art that many more embodiments and implementations are possible that are within the scope of the embodiments. Accordingly, the embodiments are not to be restricted except in light of the attached claims and their equivalents. Also, various modifications and changes may be made within the scope of the attached claims.

What is claimed is:

1. A height adjustable assembly, comprising:
a sliding member, the sliding member including a flange portion;
a receiving member configured to receive the sliding member, the receiving member including a slot;
the receiving member including a proximal portion and a distal portion, wherein the distal portion further includes a barb portion;
a frame member including a recess, wherein the recess further includes a narrow portion and a wide portion disposed inwardly from the narrow portion;
the receiving member being disposed within the recess such that the barb portion is engaged with the wide portion; and
wherein the sliding member is disposed in the slot of the receiving member and wherein the flange portion is disposed inside of the wide portion of the recess.

2. The height adjustable assembly according to claim 1, wherein the receiving member is made of a plastic with a low wear factor.

3. The height adjustable assembly according to claim 1, wherein the receiving member has a dynamic friction coefficient approximately in the range between 0.01 and 0.10.

4. The height adjustable assembly according to claim 1, wherein the receiving member has a static friction coefficient approximately in the range between 0.01 and 0.10.

5. The height adjustable assembly according to claim 1, wherein the receiving member has a dynamic friction coefficient of approximately 0.06 and a static friction coefficient of approximately 0.04.

6. The height adjustable assembly according to claim 5, wherein the receiving member is made of Nylon and the sliding member is made of Acetal.

7. The height adjustable assembly according to claim 1, wherein the barb portion is redundantly secured upon insertion of the sliding member.

8. The height adjustable assembly according to claim 1, wherein the slot includes a first portion and a second portion and wherein the cross sectional area of the first portion is substantially different from the cross sectional area of the second portion.

9. The height adjustable assembly according to claim 8, wherein the flange portion of the sliding member has a cross sectional area that is less than the first portion of the slot and greater than the second portion of the slot.

10. The height adjustable assembly according to claim 1, wherein a portion of the sliding member is configured to move through the slot in a longitudinal direction of the receiving member.

11. The height adjustable assembly according to claim 1, wherein the flange portion of the sliding member is shaped to receive a fastener head that is larger than the second portion of the slot to provide redundant security for retention.

12. The height adjustable assembly according to claim 1, wherein a gas spring piston includes a check valve acting as a restricted orifice to reduce accidental rapid descent of the height adjustable assembly.

13. The height adjustable assembly according to claim 1, wherein the receiving member is configured to retain the sliding member without the need for a tool or fasteners.

14. The height adjustable assembly according to claim 1, wherein receiving member includes at least two barb portions.

15. The height adjustable assembly according to claim 1, wherein the sliding member is connected to a linkage assembly of the height adjustable assembly.

16. A height adjustable assembly, comprising:
an outer support structure;
a frame member that is configured to move with respect to the outer support structure;
a linkage assembly used to attach the outer support structure to the frame member, the linkage assembly including a first portion and a second portion;
a pedal attached to the linkage assembly;
a pneumatic strut including a first end attached to the first portion of the linkage assembly and a second end attached to the second portion of the linkage assembly; and
wherein the pedal can be depressed to operate the linkage assembly and thereby raise the frame member and wherein the pneumatic strut provides an assisting force in operating the linkage assembly.

17. The height adjustable assembly according to claim 16, wherein the first portion of the linkage assembly is associated with a first linkage member and the second portion of the linkage assembly is associated with a second linkage member and wherein the first linkage member and the second linkage member are attached at a pivoting connection.

18. The height adjustable assembly according to claim 17, wherein the first linkage member is a straight tube-like member.

19. The height adjustable assembly according to claim 17, wherein the second linkage member is a U-shaped tube-like member.

20. The height adjustable assembly according to claim 16, wherein the pedal includes a latch-type locking mechanism.

21. The height adjustable assembly according to claim 20, wherein the pedal can be lifted to release a hook on the pedal from a latch attached to the outer support structure.
